(19) United States
(12) Patent Application Publication
(10) Pub. No.: US 2015/0149274 A1
(43) Pub. Date: May 28, 2015

(54) INTERNET MARKETING-ADVERTISING SYSTEM

(71) Applicant: William Conrad, San Diego, CA (US)

(72) Inventor: William Conrad, San Diego, CA (US)

(21) Appl. No.: 14/492,010

(22) Filed: Sep. 20, 2014

Related U.S. Application Data
(60) Provisional application No. 61/909,755, filed on Nov. 27, 2013.

(51) Int. Cl. G06Q 30/02

(52) U.S. Cl. CPC G06Q 30/0244; G06Q 30/0245; G06Q 30/0246; G06Q 30/0256; G06Q 30/0267; G06Q 30/0269; G06Q 30/0273; G06Q 30/0261
USPC 705/14.44; 705/14.41; 705/14.58; 705/14.54; 705/14.49; 705/14.72; 705/14.45

(57) ABSTRACT

This present patent builds on 61/494,133 by providing specifics on the advertiser/marketer interface, advertisement feedback and reports on the advertising campaign effectiveness. The marketer interface allows the advertiser/marketer to set up an advertising campaign, link data to their 4P key words/phrases and generate reports to show the effectiveness of their advertising efforts. This interface includes a new account setup page, a new advertisement setup page, a product/service entry page, a price entry page, rules generation page, a place entry page, a promotion entry page, an advertisement preview page, 4P contextual setup page, external 4P contextual setup page, 4P banner (display) setup page, regular banner (display) setup page, 4P mobile contextual setup page, 4P Mobile banner (display) setup page, 4P game contextual setup page, game banner (display) setup page, 4P game banner (display) setup page, 4P application contextual setup page, application banner (display) setup page, 4P application banner (display), 4P media player contextual setup page, media player banner (display) setup page or 4P media player banner (display) setup page, a marketer alert setup page and a campaign management center. Also included is an advertisement feedback system where an internet web user may leave feedback on the effectiveness of an advertisement they are viewing. Also included is a set of reports that are broken down by Account Performance, Campaign Performance, Advertisement Group Performance, Individual Advertisement Performance, Keyword Performance, Game Performance, Application Performance, URL Performance, Demographic Performance, Geographic Performance, Search Query Performance, Placement Performance, Reach and Frequency Performance, Click Fraud, Direct Feedback Analysis and a complete set of reports. Together, these reports give the advertiser/marketer a complete picture of their advertising campaign and help the marketer optimize their marketing performance.

### FIELD OF THE INVENTION

The present invention is directed to Internet contextual advertising systems and builds on our existing 61/494,133 patent. Specifically this patent address the setting up of an Internet Marketing-advertising system account to help the user display a product and/or service 4P Marketing Mix contextual smart-advertisement, on a user-search Search-Result-Page (SRP)/Web Content and site-visitor Viewer-Page. An advertisement feedback system provides direct feedback from the web site user to the advertiser/marketer, a comprehensive set of reports show the advertiser/marketer their advertisement status/performance and a 4P Marketing Mix contextual banner (display) advertisement all of which would work on a web browser, mobile internet device, computer game or in an computer application.

### BACKGROUND OF THE INVENTION

Contextual advertising selects the advertisements biased on a user's search and other information and these advertisements appear on websites and elsewhere according to predefined targets. The advertisements are chosen according to their content and displayed by automated systems to Internet users who would find them relevant.

Some contextual advertising systems scan websites for keywords and return particular advertisements back to the webpage based on those keywords. Other contextual advertising systems base their responses on the users' queries. For example, if a user is viewing a website about new cars and that website uses contextual advertising, that particular user may be targeted to see advertisements for local dealers, reviews, or auto financing.

Google adSense was one of the first major contextual advertising networks, their system displays relevant advertisements from the Google inventory of advertisers. Webmasters are given a JavaScript code to insert into their own webpages. A relevance score is calculated by a separate Google bot, Mediabot, that indexes the content of a webpage. More sophisticated systems use sentence structure independent proximity pattern matching algorithms to increase matching accuracy.

A new system of contextual advertisements with their 61/494,133 patent that built on the existing contextual advertising networks. This patent described an advertisement embedded with 4P Marketing Mix keyword/multi-words and sentence structure independent proximity pattern matching algorithm to increase matching accuracy and capability to improve advertisement Click-Through-Rate (CTR) on a user-search Search-Result-Page (SRP)/Web Content and site-visitor Viewer-Page. This includes advertisement control that measure, optimize, balance and refine online advertisement. The advertisement control provides capability to improve advertisement performance by modifying one or more product and/or service 4P Marketing Mix contextual smart-advertisement keyword/multi-words (content) at System module user Interface component.

What is needed is an effective interface for the advertiser/marketer to interface to the database, direct advertisement feedback from the internet user to the advertiser/marketer, detailed reports to show the advertiser/marketer the effectiveness of their advertisement campaign and a 4P Marketing Mix contextual/banner (display) advertisement all of which would work on an internet web browser, mobile internet device, computer game or in an computer application.

### PATENT CITATIONS

### EP1895461A1

### EP1898351A1

### US20020062245

### US20040054589

### US20040073482

### US20040186777

### US20040215606

### US20040249808

### US20050033771

### US20050234779

### US20050234953

### US20060026067

### US20060047563

### US20060136298

### US20060248062

### US20070088801

### US20070094330

### US20070121846

### US20070130014

### US20070162296

### US20070214131

### US20070239530

### US20070239737

### US20070276729

### US20080004983

### US20080010355

### US20080021898

### US20080040227

### US20080046562

### US20080147501

### US20080221892

### US20080221986

### US20080243619

### US20080262846

### US20090150507

### US20090192983

### US20090204611

### US20090319517

### US20100094878

### US20100106599

### US20100131357

### US20100161406

### US20110047164

### US20110208581

### US20120036117

### US20120053927

### US20120072291

### US20120215776

### US20120252574

### US20120324025

### US20130325603

U.S. Pat. No. 5,852,809
U.S. Pat. No. 5,950,123
U.S. Pat. No. 6,389,114
U.S. Pat. No. 6,421,707
U.S. Pat. No. 6,529,592
U.S. Pat. No. 6,603,837
U.S. Pat. No. 6,684,249
U.S. Pat. No. 6,801,604
U.S. Pat. No. 7,113,803
U.S. Pat. No. 7,346,606
U.S. Pat. No. 7,577,643
U.S. Pat. No. 7,627,559
U.S. Pat. No. 7,664,516
U.S. Pat. No. 7,676,467
U.S. Pat. No. 7,689,554
U.S. Pat. No. 7,698,165
U.S. Pat. No. 7,706,511
U.S. Pat. No. 7,716,229
U.S. Pat. No. 7,739,264
U.S. Pat. No. 7,746,496
U.S. Pat. No. 7,774,333
U.S. Pat. No. 7,809,740
U.S. Pat. No. 7,814,109
U.S. Pat. No. 7,818,315
U.S. Pat. No. 7,827,172
U.S. Pat. No. 7,860,878
U.S. Pat. No. 7,865,394
U.S. Pat. No. 7,895,221
U.S. Pat. No. 7,904,448
U.S. Pat. No. 7,962,479
U.S. Pat. No. 7,991,806
U.S. Pat. No. 8,005,716
U.S. Pat. No. 8,023,622
U.S. Pat. No. 8,024,323
U.S. Pat. No. 8,024,345
U.S. Pat. No. 8,090,706
U.S. Pat. No. 8,112,458
U.S. Pat. No. 8,117,202
U.S. Pat. No. 8,135,728
U.S. Pat. No. 8,140,388
U.S. Pat. No. 8,156,005
U.S. Pat. No. 8,171,021
U.S. Pat. No. 8,185,523
U.S. Pat. No. 8,229,091
U.S. Pat. No. 8,296,285
U.S. Pat. No. 8,301,125
U.S. Pat. No. 8,312,002
U.S. Pat. No. 8,364,540
U.S. Pat. No. 8,380,745
U.S. Pat. No. 8,423,412
U.S. Pat. No. 8,438,170
U.S. Pat. No. 8,504,575
U.S. Pat. No. 8,543,924
U.S. Pat. No. 8,612,863
U.S. Pat. No. 8,615,433
U.S. Pat. No. 8,615,442
U.S. Pat. No. 8,631,003
U.S. Pat. No. 8,650,265
U.S. Pat. No. 8,655,648
U.S. Pat. No. 8,660,901
U.S. Pat. No. 8,666,819
U.S. Pat. No. 8,688,521
U.S. Pat. No. 8,751,473
U.S. Pat. No. 8,775,471
U.S. Pat. No. 8,788,319
U.S. Pat. No. 8,812,473

### WO2000019697A1

### WO2005003920A2

### WO2006044357A2

### WO2006089223A2

### WO2009108576A2

### WO2010008800A2

### WO2010015038A1

### WO2013032640A1

### SUMMARY OF THE INVENTION

Briefly, embodiments of the present invention provide control over a context advertising campaign to drive and improve click-through-rates and purchase results. In the 61/494,133 patent, a new system of contextual advertisements was developed. This present patent builds on 61/494,133 by providing specifics on the advertiser/marketer interface, advertisement feedback and reports on the advertising campaign effectiveness. The marketer interface allows the advertiser/marketer to set up an advertising campaign, link data to their 4P key words/phrases and generate reports to show the effectiveness of their advertising efforts. This interface includes a new account setup page, a new advertisement setup page, a product/service entry page, a price entry page, rules generation page, a place entry page, a promotion entry page, an advertisement preview page, 4P contextual setup page, external 4P contextual setup page, 4P banner (display) setup page, regular banner (display) setup page, 4P mobile contextual setup page, 4P Mobile banner (display) setup page, 4P game contextual setup page, game banner (display) setup page, 4P game banner (display) setup page, 4P application contextual setup page, application banner (display) setup page, 4P application banner (display), 4P media player contextual setup page, media player banner (display) setup page or 4P media player banner (display) setup page, a marketer alert setup page and a campaign management center. Also included is an advertisement feedback system where an internet web user may leave feedback on the effectiveness of an advertisement they are viewing. Also included is a set of reports that are broken down by Account Performance, Campaign Performance, Advertisement Group Performance, Individual Advertisement Performance, Keyword Performance, Game Performance, Application Performance, URL Performance, Demographic Performance, Geographic Performance, Search Query Performance, Placement Performance, Reach and Frequency Performance, Click Fraud, Direct Feedback Analysis and a complete set of reports. Together, these reports give the advertiser/marketer a complete picture of their advertising campaign and help the marketer optimize their marketing performance.

Once having read through the present disclosure and having studied the accompanying illustrations, artisans will no doubt come to understand the many variations and alternatives that are made possible. These derivatives are, however, a part of the scope and breadth of the subject matter being claimed herein.

### RELATED APPLICATIONS

This Application claims benefit of United States Patent Application titled INTERNET MARKETING-ADVERTISING SYSTEM. Such is incorporated herein by reference in its entirety.

### BRIEF DESCRIPTION OF THE DRAWINGS

The foregoing and other objects, features and advantages of the invention will be apparent from the following more particular description of preferred embodiments of the invention, as illustrated in the accompanying drawings in which like reference characters refer to the same parts throughout different views. Others will be readily apparent to those skilled in the art.

FIG. 1 is an illustration of a New advertisement setup of the present invention.

FIG. 2 is an illustration of a Price entry setup of the present invention.

FIG. 3 is an illustration of an External advertisement setup of the present invention.

FIG. 4 is an illustration of a Banner advertisement setup of the present invention.

FIG. 5 is an illustration of a 4P banner/display advertisement setup of the present invention.

FIG. 6 is an illustration of a 4P game advertisement setup of the present invention.

FIG. 7 is an illustration of a 4P application advertisement setup of the present invention.

FIG. 8 is an illustration of a Market alert setup of the present invention.

FIG. 9 is an illustration of an Account performance report setup and graph of the present invention.

FIG. 10 is an illustration of a Keyword performance report setup and graph of the present invention.

FIG. 11 is an illustration of a Search query report setup and report of the present invention.

FIG. 12 is an illustration of a Click fraud analysis of the present invention.

FIG. 13 is an illustration of a Direct feedback examples, analysis setup and report of the present invention.

FIG. 14 is an illustration of a Rule Development of the present invention.

FIG. 15 is an illustration of a 4P Media Player advertisement setup of the present invention.

FIG. 16 is an illustration of a Game advertisement performance setup and report of the present invention.

FIG. 17 is an illustration of an Application advertisement performance setup and report of the present invention.

FIG. 18 is an illustration of a Media Player advertisement performance setup and report of the present invention.

FIG. 19 is an illustration of a URL report setup and report of the present invention.

FIG. 20 is an illustration of a Demographic report setup and report of the present invention.

FIG. 21 is an illustration of a Geographic report setup and report of the present invention.

FIG. 22 is an illustration of a Cost Per Mille and Click Through rate account performance report of the present invention.

FIG. 23 is an illustration of a Click Through Success and Return On Investment account performance report of the present invention.

FIG. 24 is an illustration of an Account performance report of the present invention.

FIG. 25 is an illustration of a Contextual advertising algorithm of the present invention.

FIG. 26 is an illustration of a 4P Banner advertising algorithm of the present invention.

FIG. 27 is an illustration of a Banner advertising algorithm of the present invention.

FIG. 28 is an illustration of a Reach and Frequency report setup and report of the present invention.

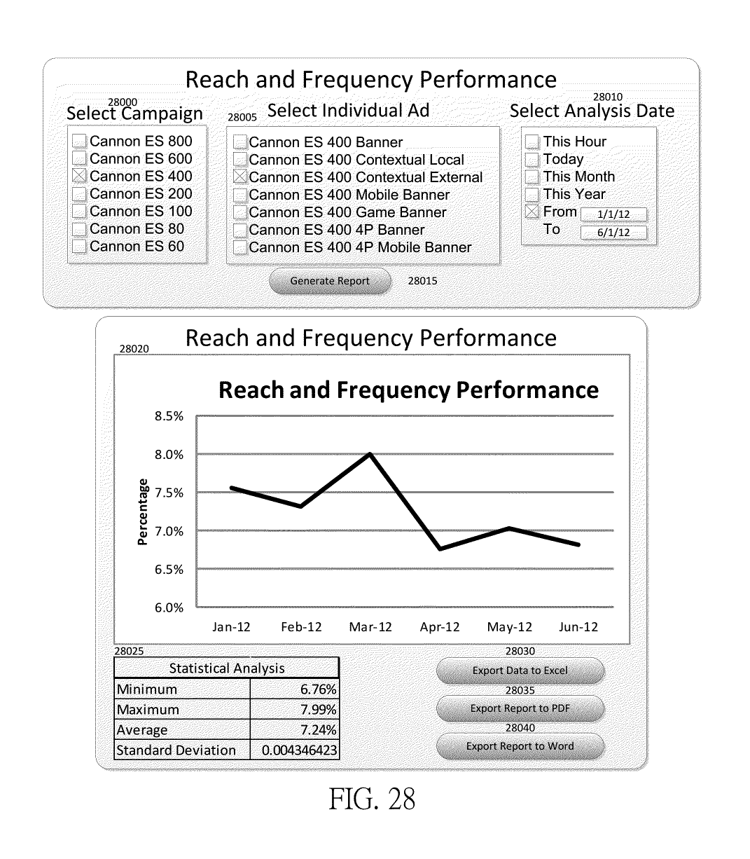

### DETAIL DESCRIPTIONS OF THE INVENTION

All illustrations of the drawings are for the purpose of describing selected versions of the present invention and are not intended to limit the scope of the present invention.

In the 61/494,133 patent, a new system was developed that selects and displays a product and/or service 4P Marketing Mix contextual smart-advertisement, on a user-search Search-Result-Page (SRP)/Web Content and site-visitor Viewer-Page that is generated from the product and service owner or provider of advertisements included within posted and or published websites with regard to additional information. In a further embodiment of the 61/494,133 patent, the marketer has the ability to interface to set up an account, modify their account, set up advertisements, have marketer alerts and have a variety of reports to show the performance of their advertisements. The marketer starts by setting up or modifying their account by: entering their user name, password, first name, last name, job title, phone number, email address, company name, address (street, city, state, zip code, and country), business type, NAIC code, currency type, web site language, capacha (internet security code) and business URL. From there, the marketer can set up or modify an advertising campaign. The marketer starts by first selecting what is being advertised. This can be a product or service. The advertiser then selects the time of day Advertisement is to run, the days per week and the length of time [in days, months or years] that the advertisement is to run. For example, the marketer could have an advertising campaign could be set up just to run over the holidays to specifically target users or the marketer could have a different advertisement campaign to run over the weekend. The marketer then selects the daily budget and the geographical location advertisement is to run. This location could either be in the form of a radius around a geographic location or it could be an entire City, State or Country(s). The radius is selected graphically using a map and is useful for mobile advertisements. The marketer is also able to select multiple locations for an advertisement. For example, a chain of auto parts store could advertise oil filters in each city that they have store locations and not cities that they do not have store locations. This would save time for the marketer by having one campaign serve multiple locations. The marketer then selects the campaign name and the advertisements type. The campaign name will be used by the marketer to manage their campaign and to set up and display reports. The advertisement types can be web search 4P contextual, external 4P contextual, 4P Banner (display), regular banner (display), 4P mobile contextual, 4P mobile banner (display), 4P game contextual, game banner (display), 4P game banner (display), 4P application contextual, application banner (display), 4P application banner (display), 4P media player contextual, media player banner (display) or 4P media player banner (display). They then give details about the product including a description, manufacture, product type, UPC code, model number and any other pertinent information. The other pertinent information can include alternate names for the product, competitive products, similar model numbers or related products. The marketer then select if the advertisement contains explicit material and is not safe for a work environment. Bots would check key words and phrases for explicit material before an advertisement is posted. In addition, the images of a banner advertisement would be reviewed for content.

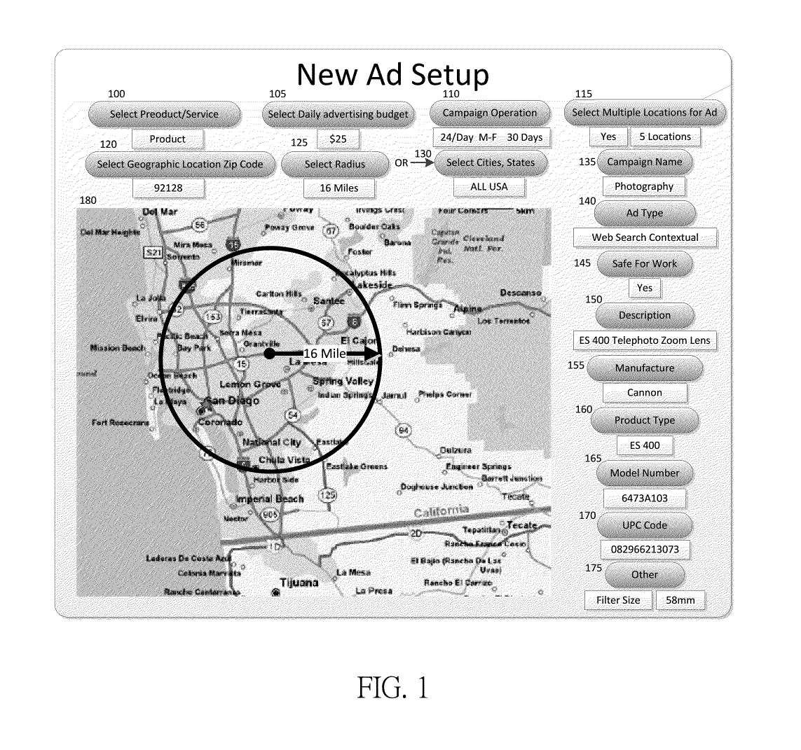

Referring now to FIG. 1, the setup for a new advertisement is presented. The marketer begins their advertising campaign by selecting if this is a product or service (100) they then select a daily advertising budget (105). The marketer has already selected their currency preference in the account setup. The advertiser then selects the time and duration that the advertisement is to run (110). The marketer then selects the geographical location advertisement is to run (120), (125) with a zip code and a radius or they select a city or state (130) and this is represented graphically by a map (180). The marketer may select multiple locations for an advertisement (115) campaign. The marketer then selects the campaign name (135) and advertisement type (140). The marketer then enters in the details about the product including description (150), manufacture (155), product type (160) UPC code (170) and any other pertinent information (175).

The 4P (product/service, price, place promotion) are entered individually by the marketer for each advertising campaign. For every key word, there is a marketing phrase and a rank associated with the key word. The rank determines the priority of the key word/key phrase combination and this rank is use by the database (server) algorithm to set the priority for displaying the phrase in an advertisement. The marketer has the ability to update the key word, have the database (server) algorithm suggest key words and scan an internet page for key words suggestions.

Some key words have linked data that can be automatically updated. An example of this would be the current price of an item. The marketing interface would allow the marketer to link to this data directly or the marketer could provide this information through their own internal API and this data would be sent to the database. In this way, the marketer only has to keep their own database up to date. Some key words may have rules associated with them. For example the marketer could display a key phrase only during the time that a sale is going on.

The marketer may also enter in negative key words. Negative key words direct an advertising campaign away from where the marketer does not want their advertisement displayed. For example, if a campaign is only for a new item, the keyword ‘used’ would direct web users away from the new product that the marketer is offering. This would save the marketer money by avoiding the cost of serving a non-beneficial advertisement to a web user. Once the advertisement campaign has been set up the marketer can view a sample 4P promotion to see how the combination works together.

The marketer starts by first entering information about the Product or Service.

The marketer selects a key word that describes their product or service and then they enter a specific phrase that contains the key word. For example the key word could be ‘improved’ and the key phrase could be “improved light capture over last year's model.” The key word does not have to just be a single word as it can be several words like “Extended Warranty” or “Buy One Get One Free”. The key phrase does have to have the key word in it in the exact same order such as for “Extended Warranty” it could be “We offer a 30 day extended warranty”. [Note that a system could be set up where the key word is not represented verbatim in the key phrase. This alternative system makes it harder for the search algorithm to operate but would still work.] After the key phrase is entered, the marketer can enter the ranking of the key phrase. The higher the ranking, the more priority is given to a phrase when the algorithm generates an advertisement. The marketer is able to update their ranking, scan their web site for key words, suggest similar key words, remove an entry and edit their phrases. In this system, the marketer may only one key phrase per key word. However a system could be set up where there can be multiple key phrases per single key words. This alternative system makes it harder for the search algorithm to operate but would still work.

The marketer then enters in negative key words which direct searches away from their advertisement. For example if a product is new the marketer would direct the user away from key words such as antique, restored used or vintage. The marketer assigns a rank to these negative key words as well. The higher the negative key word rank, the further the advertisement engine prevents an advertisement from being served to a web user. The marketer is able to update the ranking and remove entries.

Price key words are entered in the exact same way as Product/Service is entered. The main difference is the ability to have rules and linked information. Linked information gives the marketer the ability to have real time information displayed in their advertisement. For example, the current price could be linked in for the phrase wholesale price. The marketer would enter in the key word “price” and the key phrase “$ ( ) after rebate price”. The linked price data is represented by ‘( )’ for the wholesale price. Note that ‘( )’ is an example place holder and any combination of letters, numbers, graphics or characters could work for showing where linked data is to be placed. The marketer would then enter in where the linked data (in this case price) is located. This data would be in the marketer's web site associated with the particular product or service that this advertising campaign is intended to represent. The marketer would direct where on their web page the linked data is contained. So when the web user was served a 4P advertisement they would see the phrase “$19.95 after rebate price” where the ‘19.95’ is the linked current price of the product/service and this price was taken in real time from the marketer's site. There is also the ability for an interface to the marketer's database or API so that this data could be obtained in rapidly with much less computer overhead. This information could also be scanned by a bot for price changes. Note that if the linked data is not present or cannot be retrieved in a timely manor, the advertisement algorithm goes to the next ranked key word to generate the advertisement. Rules are used to actively direct a phrase based on current linked information. For example a marketer can direct the price of their item to be less than a competitor. Rules are described in the next section. Just like Product/Service entry, the marketer can update their key words and enter in negative key words.

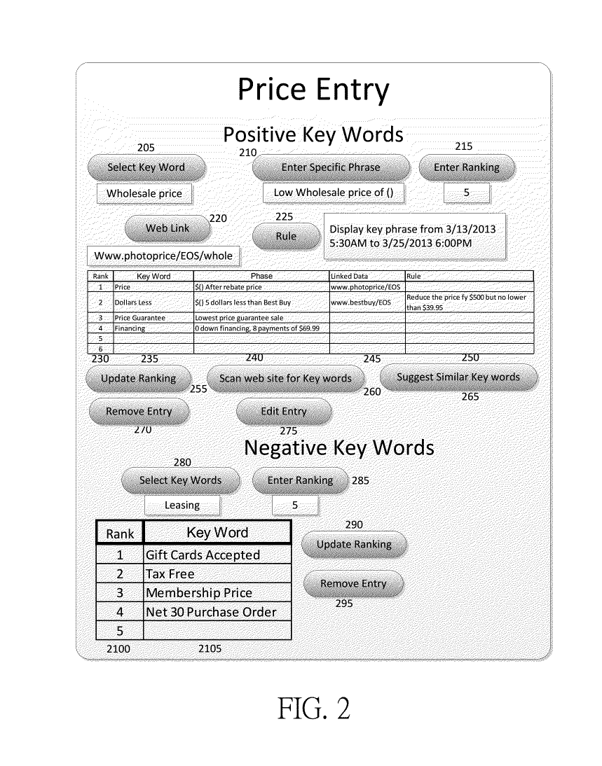

Referring now to FIG. 2, the setup for entering the price key words is presented. The marketer starts by entering a price key word (205). These can be from a pre-defined list or the marketer can make up a new key word. The marketer would then enter in the key phrase (210). This phrase must contain the key word(s) in the same order so that the search engine can key in on them. The marketer then enters in the ranking (215) of the price key word/phrase. The marketer can enter in linked data if their key phrase has linked data (220) by using a web link, API or entry into the markets database. They then enter in a rule (225). There is a list of their key words and phrases with rank (230) key words (235) phrases (240), linked data (245) and rules (250). The marketer can update the ranking (255) scan their web site for key words (260) have key words suggested to them based on their existing key words and product/service information (265), remove a key word/phrase (270) and edit an entry (275). Negative key words are entered (280) with their ranking (285) and displayed (2100) (2105). The negative key word entries can be updated in rank (290) and removed (295)

Key word rules apply to linked data, time, graphical location and user information. There are 5 basic rule types. The first rule compares linked data to a set value. The linked data could be on the marketer's site or on a competitor's site. If the data is within a certain range, then the key phrase is not displayed. For example if there is no inventory available the key phrase (or advertisement) would not be displayed. This would prevent wasting advertising time if a product is not available for sale. The second rule take the linked competitor price and reduces it by a certain amount but no lower than a fixed amount. This allows a marketer to stay ahead ofa competitor's price automatically. The third rule sets the date and time that a key phrase (or advertisement) is displayed. For example the key word is “Black Friday Sale”, then the key phrase “Black Friday Sale” would only be displayed during the hours that the promotion takes place. The forth rule looks at the web user and does not display the key phrase (or advertisement) if it meets a certain criteria. For example if the marketer were advertising teenage music they would not target an older web user. The fifth rule restricts key words to a specific location. The user would use the same method as depicted in FIG. 1 (120 (125) (130) (180) to select a zip code, city start or radius. This would localize sales and key phrases to specific regions. The marketer can also combine rules. For example the marketer could have an advertisement that runs during a certain time period but only if there is inventory available.

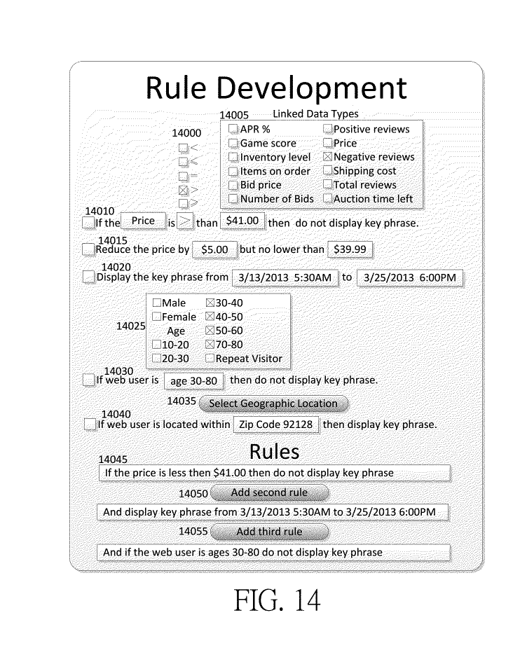

Referring now to FIG. 14, the setup for developing key word rules is presented. The marketer starts by selecting a rule to develop by checking the box next to the rule. The first rule (14010) displays a key phrase or advertisement if the linked data meets a certain criteria (14000). The linked data is identified by type (14005). The marketer can also can take a competitors price and make it their own price by reducing the competitors price by a certain amount but no lower than a fixed limit (14015). The marketer can select a time that the key phrase is valid (14020). The marketer can use web user demographic and other information (14025) to select if a key word phrase should be displayed (14030). The marketer can also select geographic information to restrict a key phrase to a certain region (14040). The marketer does this by clicking a link (14035) and a selection screen appears similar to FIG. 1 (120) (125) (130) (180). The rule that the marketer has develop is displayed (14045) and the marketer can combine it with additional rules (14050) (14055).

Place key words are entered in the exact same way as Price is entered. Place also has the ability to have linked information. For example, if the place key word is “Express Delivery” then the key phrase could be “express delivery available”. A linked example could be “items in stock” and the key phrase could be “( ) items in stock—Buy Now!”which could display as “51 items in stock—Buy Now!”.

Promotion key words are entered in the exact same way as Price key words are entered. Just like price, promotion also has the ability to have linked information. For example, a promotion key word could be “low price” and the key phrase could be “Our best low price ever”. A linked example could be “highly rated” and the key phrase could be “( ) highly rated!”which would display as “IHHHH highly rated” where the filled in stars are linked from the marketers site.

Once the data for an 4P contextual advertisement has all been entered, the marketer can preview the advertisement. This would show the marketer all the contextual possibilities, the rules functioning and the linked data being gathered. The marketer could then judge the effectiveness of their advertisement and make corrections if necessary.

In another embodiment of the present invention, the marketer is also able to set up external [to the search site]4P contextual advertisements. In an external advertisement, there are many web sites that a 4P contextual advertisement could appear in and this would allow the marketer to reach a wider audience than just the search site. 4P contextual advertisements are not the result of a search but instead rely on information about the web user and the information on a web site to develop a 4P contextual smart advertisement. The marketer starts the process for creating an advertising campaign by entering in their 4P information just like a normal contextual advertisement. [Note: the marketer can copy and paste from a different advertising campaign so there is less data entry by the marketer.] It is beneficial for the marketer to customize their 4P key words/phrases/linked data/rules to take advantage of a particular external web site or groups of web sites. After entering in the 4P and other basic information, the marketer enters in what types of sites they are interested in marketing their product. For example if the marketer was advertising an automobile oil filter, they might look for web sites for auto parts web sites. The marketer would then select selects the all the sites that they would advertise on. These sites available to the marketer would already have agreements in place with the users of this technology in advance. The marketer can do a suggested search and have the database (server) algorithm come up with possible matches. The matches may be local [such as a local restaurant's web site] or national [such as amazon.com]. The suggestions may be related to what the marketer is promoting or unrelated. Once a site has been found, they can add it to their list. The list if advertising sites is displayed with a ranking and the marketer put the sites at the top of the rank that they feel with give optimal results. After the data has been entered, the marketer can change the ranking of the advertising web sites or remove advertising web sites. The marketer would change the priorities or update the ranking based on reports showing the performance of their advertisements based on reports generated by the database (server) algorithm. The advantage to having multiple advertising campaigns on external websites is that the marketer can selectively target different sites and adjust the key words/phrases to maximize their advertising effectiveness to external web site types.

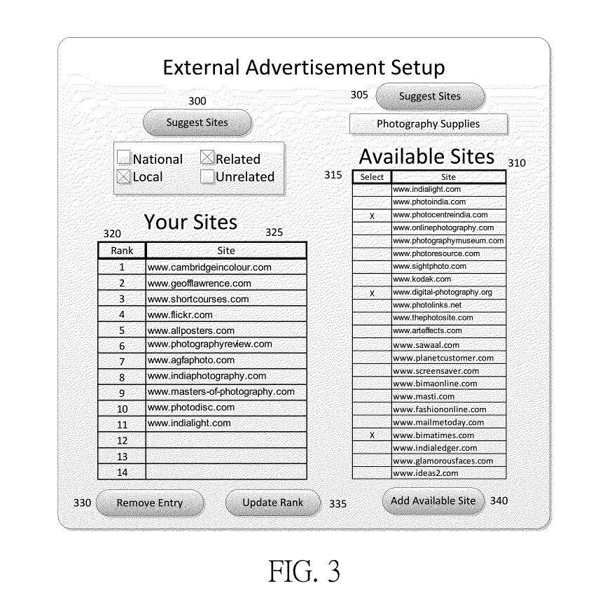

Referring now to FIG. 3, the setup for an external 4P contextual advertisement is presented. The market starts by typing in a phrase that is related to their product to search for possible sites (305). The sites that are displayed (310) are ones that have agreements in place to serve advertisements and once selected (315), they can be added to the marketers list (340). The marketer can also have sites suggested to them (300) that are local, national related or unrelated to their 4P key words, and product/service information that has been previously entered. These items would be displayed (310) and if selected (315) could be added to their list of advertising sites (340). There is a list of sites (325) that the marketer uses to advertise their external 4P contextual advertisement and their rank (320). The lower number on the rank, the more priority that site is given to the marketers 4P contextual advertisement. The marketer is able to remove an entry from the list (330) and update the ranking of the sites (335).

In another embodiment of the present invention, the database (server) algorithm is able to display banner (display) advertisements using 4P smart technology. The banners (display) advertisements used by the database (server) algorithm would be created in advance by the marketer, graphic artist, advertising agency or computer programmer. The marketer starts by entering in the campaign information just like 4P contextual advertisement. [Note: the marketer can copy and paste from a different advertising campaign so there is less data entry by the marketer.] The difference between a contextual campaign and a banner (display) advertising campaign is that there are only key words present and no key phrases. The advantage of using 4P key words to place a banner (display) advertisement is that the key words describe what is being conveyed by the banner (display) advertisement. Each of the 4P key words associated with the banner (display) advertisement would describe an aspect of the banner (display). The result is that a banner (display) is better placed to the web user because the system [the database (server) algorithm] knows more about the content of the banner (display) advertisement. This is due to the marketer having exactly described their product/service in a way that is better interoperated by the advertisement placing algorithm and therefore more accessible/relevant to the web user. In addition, several banners (displays) for the same subject matter can be created that would better target the user based on slightly different key words. For example, a banner for the same subject matter could have different prices or different sales or different shipping options. The key words would reflect this and their ranking would be adjusted by the marketer and the database (server) algorithm for optimum placement to the web user. The process starts by the marketer loading the banner (display) into the database (server) algorithm. The banner (display) may be an animated image (such as a JPG, MPG or GIF), video clip (with or without audio), a static image (such as a JPG or GIF), interactive image (such as a JPG or GIF), transparent image (such as a JPG or GIF), an audio file, an interactive flash, a static flash, an interactive java script, a static java script or an HTML file. The marketer has already described the campaign as is safe for work viewing in the campaign set up section but the graphics would have to be approved before posting to be declared safe for the sites that were intended for a general audience. The location of where the banner (display) is hosted is then entered. The marketer ten determines if the banner (display) advertisement would be hosted by the database (server) algorithm or by an external site. The marketer is then able to view the loaded banner (display). The dimensions of the banner (display) are also displayed.

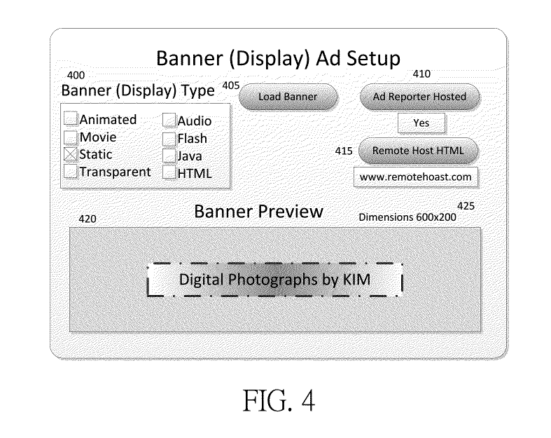

Referring now to FIG. 4, the setup for an external banner (display) advertisement is presented. The market starts by selecting the banner (display) type (400) and then loads the banner (display) (405) into the server. The marketer can select if the banner is hosted locally (410) or remotely (415). The marketer can then preview their banner advertisement (420) and see the size of the graphics (425) [if applicable]. In another embodiment of the present invention, the database (server) algorithm is able to generate a 4P banner (display) advertisement by using key words to select key phrases and then generate a graphical 4P banner (display) advertisement. The advantage of the 4P banner (display) advertising format is the flash/appeal of a banner advertisement is combined with targeted contextual content. These 4P banner (display) advertisements would be selected/served by the same algorithm type that produces 4P contextual advertisements. The marketer starts by entering in the campaign information, 4P key words/phrases/linked data/rules just like 4P contextual advertisement. [Note: the marketer can copy and paste from a different advertising campaign so there is less data entry by the marketer.] The marketer then selects the size of the advertisement in pixels from a pre-determined list of sizes [if applicable as some audio only advertisements do not have a player interface and would not have this option]. The available banner (display) advertisement sizes would be from several pre-determined sizes that are rectangular, square or other shape to fit the target location. The marketer would then select the type of advertisement which would be: animated, flash, html, audio, video or static display. The marketer would then select a background for the banner (display) advertisement which could be a solid color, a pattern or animation. The marketer would then place the key phrases starting with Product/Service. The key phrases are selected in the same way as a 4P contextual advertisement campaign. This gives the advantage of having a banner (display) advertisement with 4P information that is targeted at the user. In addition this information can be updated in real time with linked data and have rules associated with the key words/phrases. For example a banner (display) advertisement could show the web user the level of inventory available. Another example could be that a banner (display) advertisement would not be served to a user as there is no inventory available.

The marketer would place a phrase into the area in the advertisement by using a box to show where the text would be displayed for the particular advertisement size they have chosen. The marketer would also select the font, the color (solid, pattern or animation). The software would automatically select the size of the font in order to fit the key phrase. This size would change depending on the number of characters in the key phrase. The marketer would be warned when a key phrase had too many letters and would make the display too small to be viewed. The marketer would do the same for Price, Place and Promotion. All of the key words/phrases and rules would be entered in a manner similar to FIG. 2 and FIG. 14.

The marketer has the ability to select what happens when the web user moves their curser over the advertisement. This is available for web browsers, game systems, media players or applications that have the ability to sense curser movement. The 4P's may change, an animation may start, the background could change, a sound may play or a static graphic image may update. The marketer may upload their company logo into the banner advertisement space. The market may also add additional graphics to their 4P banner (display) advertisement. This can include a picture of the product, pre generated graphics such as arrows, animations or other graphics to get the web users attention. The marketer has already described the campaign as is safe for work viewing in the campaign set up section but the graphics would have to be approved before posting if declared safe. The marketer can then select/manage animations to be generated or placed into the advertisement. The marketer can also select/manage sounds to be placed into the advertisement. When all the information is present, the marketer can view one or many sample advertisements that show the different 4P's, curser interaction, animation and sounds.

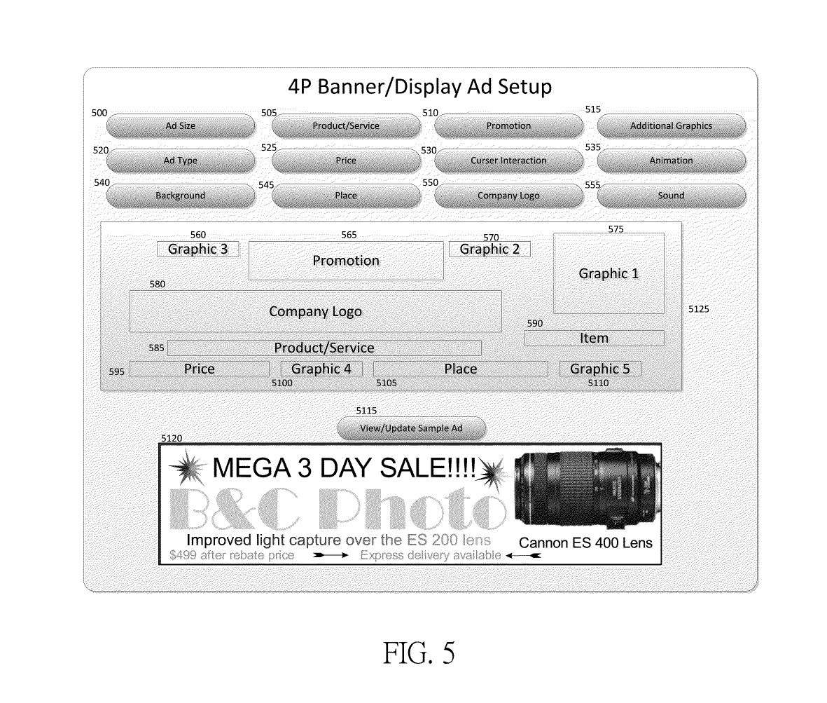

Referring now to FIG. 5, the setup for a 4P banner (display) advertisement is presented. The marketer has already entered the information about their advertising campaign and the 4P key words/phrases and rules in a manner similar to FIG. 2 and FIG. 14. The marketer starts by selecting the advertisement size (500) the advertisement type (520) and the background (540). The marketer then selects the product/service key phrase (505) to place this key phrase text. This would bring up a text box (585) in the banner (display) work area (5125). The marketer would place and size the text box where the marketer wished to have their product/service key phrase displayed within the 4P banner (display) advertisement. For the example in FIG. 4, this is in the lower area of the advertisement (585). The marketer would also select the font, the color (solid, pattern or animation) in this same step. The marketer would do the same for Price (525) (595) Place (545) (5105) and Promotion (510) (565). The marketer can then select the curser interaction (530) [if any] that their advertisement would have. This would allow the marketer to have their advertisement change as the web user moved their curser over the advertisement. The marketer could them place their logo (550) within (580) the banner (display) work area (5125). The marketer can also place (515) additional graphics within (560) (570) (5100) (5110) the banner (display) work area (5125). The marketer may also places animations (535) or sounds (555) into their banner (display) advertisement. Once completed the marketer may view one (5115) or many sample advertisements (5120). By pressing this view button several times, the marketer can display several iterations of the 4P key phrases to see how different combinations are sized within the text box.

In another embodiment of the present invention, the database (server) algorithm is able to serve 4P advertisements on mobile devices. The types of advertisements are 4P contextual, external 4P contextual banner (display) and 4P banner (display) advertisements. The main difference between a standard advertisement and a mobile advertisement is that there is less advertising screen (display) space and the location of the mobile device is more important. Since there is less advertising space, it is essential that each advertisement be as effective as possible and 4P targeted advertisement allow the marketer to specifically target the mobile user.

The marketer sets up a 4P contextual advertisement just like they would for standard web search 4P contextual advertisement, or 4P external contextual advertisement. The difference is that the marketer selects key words that take advantage of the mobile device. The marketer also concentrates the location of their advertisement radius keeping in mind that the web user that is not tied to a fixed location. It is advantageous for the marketer to optimize their key words/phrases to focus on the location of the mobile web device. [Note: the marketer can copy and paste from a different advertising campaign so there is less data entry by the marketer.]

Mobile banner (display) advertisements are smaller on portable devices so they are set up for mobile applications in advance. 4P mobile banner (display) advertisements are set up the same way that a standard 4P banner (display) advertisement is set up except as described earlier in this patent except they are in a smaller format. FIG. 5 (500) would have advertisement sizes specific for mobile applications.

Standard banner (display) advertisements are set up the same way that standard banner (display) advertisements are set up except as described earlier in this patent except they are in a smaller format. FIG. 4 (405) would have advertisement sizes specific for mobile applications. Just like mobile contextual advertisements, the key words would be targeted to the mobile user.

Multiple campaigns can be set up with small geographic locations to specifically target the mobile web user. The advertisement server algorithm would keep track of which mobile advertisements and 4P key word combinations are most effective for each location. The database (server) algorithm would then adjust the key word/phrase weights to more effectively target users with the most effective 4P combination. The database (server) algorithm for serving the advertisement would be optimized to serve mobile advertisements based on location and adjust key word weights based on location as well as the standard factors. The algorithm would also take advantage of the location information to suggest advertisements. These advertisements could be unrelated to the search and be for products or services near the mobile web user. For example if a web user were in a mall, a restaurant advertisement could be displayed even though the web user did a clothing search. The database (server) algorithm would have information stored about the food preferences from searches past and be able to serve the best possible restaurant advertisement. There will likely be several different marketing campaigns for mobile applications based on specific locations. The marketer will easily be able to copy, paste and edit a campaign to make several targeted campaigns that are slightly different. The marketer would then optimize each campaign based on the reports that are generated. The marketer can also take advantage of location rules to direct their key words/phrases. For example they might have a place key phrase “near the colorful fountain” that would only appear if the mobile user is near that place in a mall. This would direct the mobile user to a product or service near the colorful fountain [their present location].

In another embodiment of the present invention, the database (server) algorithm is able to serve 4P advertisements that are displayed beginning/during/end of a computer game. Often these obtrusive/incentivized advertisements appear at the beginning of a game and stay there for a few seconds. Advertisements are also appearing inside of games in the background, and as part of the game. For example, a game player may be walking down a virtual street inside the game and there would be a billboard with a real advertisement on it. Another example is that within the game is a store that the game player is able to purchase real merchandise. The product/service advertised within the game may or may not be game related. Having advertisements as part of a game allows users to download a game for free and the publisher of the game can generate revenue without ever charging the user.

The marketer sets up a 4P contextual advertisement just like they would for standard web 4P external contextual advertisement. The difference is that the marketer selects key words/phrases/rules that take advantage of a game environment. In addition, there are rules and linked data to make the advertisement more appealing. The marketer can optimize their key words/phrases/rules to focus on game type advertisements. [Note: the marketer can copy and paste from a different advertising campaign so there is less data entry by the marketer.] It would be beneficial to tailor the key words/phrases to the game type as this would maximize effectiveness.

The marketer starts by entering in the campaign information, 4P key words/phrases, linked data and rules as described earlier in the patent. The marketer then enters the advertisement type. The three types are 4P contextual, banner (display) and 4P banner (display). The marketer would then select one or several game type(s) from a list that contains the various game types. The marketer would then select individual game titles from a list of available games. These games would have to have agreements in in advance with the database (server) algorithm. The marketer has the option of changing the rank and remove entries. The marketer can also have games suggested that are related to their game type and key words. Or they can have games suggested that are unrelated. For a banner (display) advertisement, the marketer would enter in their banner (display) and 4P banner (display) advertisement in the same manner as previously described in the patent. The difference is that the marketer would tailor the banner (display) advertisement for a game environment.

As the game is played the game player would be presented with advertisements. The advertisement server algorithm would keep track of which advertisements and 4P key word combinations are most effective on each game. The database (server) algorithm would then adjust the key word!/phrase weights to more effectively target users with the most effective 4P combination. In this way the game player is served the most effective advertisements. The marketer would be presented with reports that show how effective their game advertisement campaign is and they can adjust their particular key words/phrases, rules and marketing strategy accordingly. There will likely be several different marketing campaigns for the individual games and game types to optimize the key words/phrases, rules and marketing strategy for each game genre.

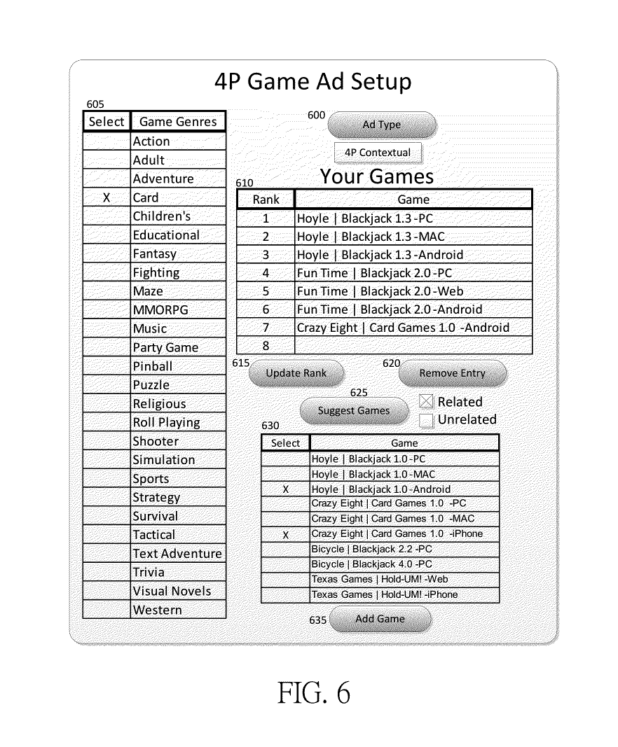

Referring now to FIG. 6, the setup for a 4P game advertisement is presented. This particular example is for card type games. The marketer has already entered in the campaign information, 4P key words/phrases/linked data/rules. An example of this is in FIG. 1, FIG. 2 and FIG. 3. The marketer starts by selecting the advertisement type (600). They then select (605) a game type from a list of game categories and have the database (server) algorithm suggest games (625). The suggestions also take into account the campaign information and the key words/phrases. These games can be related to the search or unrelated. The suggested games (630) have a game publisher, game title, game version and which platform they are on. If the marketer likes the suggested game (630) they can add the game (635) to their list of games (610). The list of games is ranked such that the lowest number has the highest priority for advertisements. The marketer can update the rank (615) or remove entries (620). The ranks would be updated by the marketer based on report information of how effective each game is at advertising the marketer's product/service.

In another embodiment of the present invention, the database (server) algorithm is able to serve 4P advertisements that are displayed within a, internet equipped computer application on a PC, mobile, tablet, embedded system or game console (application). Just like games, the obtrusive/incentivized advertisements often appear at the beginning or end of the application for a few seconds. Advertisements have also become a standard fixture of an application during normal operations of the application. Advertisements can be used instead of paying for the application. This allows users to download an application for free and the publisher of the application can still generate revenue without charging the application user.

The marketer starts by setting up an application 4P contextual advertisement just like they would for standard 4P external contextual advertisement. The difference is that the marketer selects key words/phrases/linked data/rules that take advantage of an application environment. The marketer can optimize their key words/phrases/rules to focus on application type advertisements. [Note: the marketer can copy and paste from a different advertising campaign so there is less data entry by the marketer.] It would be beneficial for the marketer to tailor the key words/phrases to the application type as this would maximize advertisement effectiveness.

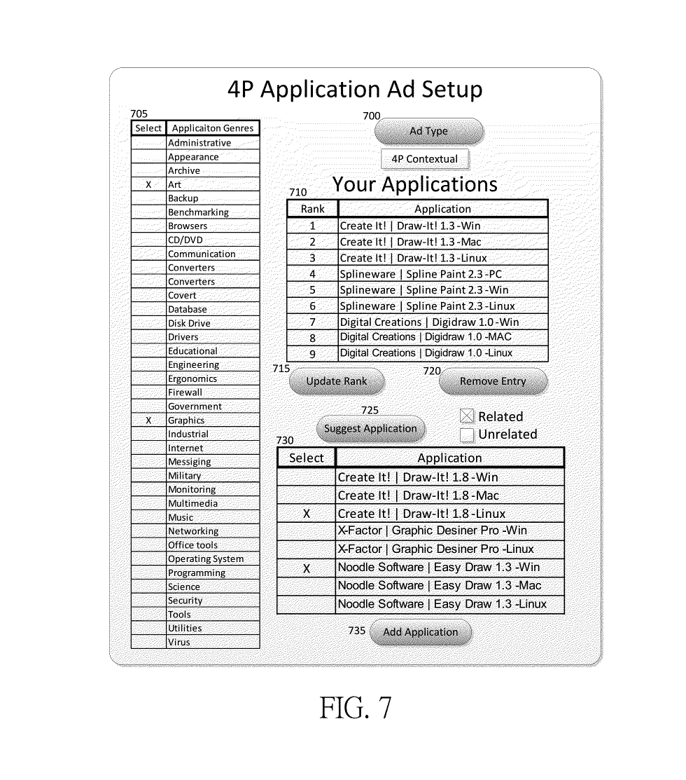

The marketer starts by entering the advertisement type. The three types are 4P contextual, banner (display) and 4P banner (display). The marketer would then select one or several application type(s) from a list that contains the various application types. The marketer would then select individual application titles from a list of available applications. These applications would have to be selected and have agreements in place in advance by the database (server) algorithm. The marketer has the option of changing the rank and remove entries. The marketer can also have applications suggested that are related to their application type and key words. Or they can have applications suggested that are unrelated. For a banner (display) advertisements, the marketer would enter in their banner in the same manner as described in FIGS. 4 and 5 earlier in the patent. As the application is used, the user would be presented with advertisements. The advertisement server algorithm would keep track of which advertisements and 4P key word combinations are most effective for each application. The database (server) algorithm would then adjust the key word/phrase weights to more effectively target users with the most effective 4P combination. In this way the application user is served the most effective advertisements. The marketer is presented with reports that show how effective their application advertisement campaign is progressing and the marketer can adjust their particular key words/phrases/rules and marketing strategy accordingly. Referring now to FIG. 7, the setup for a 4P application advertisement is presented. This particular example is for an art/graphics type application. The marketer has already entered the information about their advertising campaign and the 4P key words/phrases/linked data/rules. An example of this is in FIG. 1, FIG. 2 and FIG. 3. The marketer starts by selecting the advertisement type (700) which would be 4P contextual, banner (display) and 4P banner (display). They then select (705) an application type from a list of application categories and have the database (server) algorithm suggest applications (725). The available applications already have agreements with users of this technology to have advertisements served to them. Note that in order for the advertisements to work, the application would have to have internet access. The application suggestions come from the selected application categories, the campaign information and the key words/phrases. These applications can be related to the search or unrelated. The suggested applications (730) have an application publisher, application title, application version and the platform [operating system] they run on. If the marketer likes the suggested application (730) they can add the application (735) to their list of applications (710). The list of applications is ranked such that the lowest number has the highest priority for advertisements. The marketer can update the rank (715) or remove entries (720). The ranks would be updated by the marketer based on report information of how effective each application is at advertising the marketer's product or service.

In another embodiment of the present invention, the database (server) algorithm technology is able to serve 4P advertisements that are displayed on a Digital Video Recorder (DVR) or Digital Media Receiver or BlueRay/DVD player with internet capability or TV that is equipped with internet streaming. A DVR [sometimes called “plus box”] is a device that has a hard disk or memory that stores video/streaming media for immediate playback or later playback to a computer monitor or television. The video/streaming media is obtained with an over the air tuning device or a cable tuning device or satellite tuning receiver or through the internet. Some examples of this technology are TIVO, Replay TV, DirecTiVo, DISHPlayer, DishDVR, Scientific Atlanta Explorer 8xxx, Time Warner Total Home DVR or AT&T U-verse. A Digital Media Receiver [sometimes called: connected DVD, digital audio receiver (DAR), digital media adapter, digital media connect, digital media hub, digital media player, digital media streamer, digital video receiver, HDD media player, media extender, network media player, networked DVD, networked entertainment gateway or wireless media adapters] is a dedicated internet device that displays streaming video on a computer monitor or television streaming media from the internet and it may or may not have a hard drive or memory to store the media. Some examples of this device are: Apple TV, Roku, Squeezebox, Boxee Box or NeoTV. An internet equipped BlueRay/DVD player is a standard BlueRay/DVD set top box that uses an internet connection to stream video/media on a computer monitor or television. An internet equipped television or computer monitor with streaming is a standard television or computer monitor with additional hardware that allows streaming video/media to be displayed on the television or computer monitor. All of these devices have an internet connection and are able to stream video/media to users. Just like games, advertisements are present on the system and often appear before, during or after the video/media. These advertisements can also have feedback. This advertising feedback may or may not be accessible through the remote control for the device. This feedback could be presented to the marketer through the database (server) algorithm feedback reporting system. Advertisements have also become a standard fixture during normal operations of the streaming/recording device. 4P technology allows marketers to go beyond branding type applications to more targeted advertising.

The marketer may set up a media player 4P contextual advertisement just like they would for standard 4P external contextual advertisement. The difference is that the marketer selects key words/phrases/linked data/rules that take advantage of the media player environment. The advertisement server algorithm would keep track of which advertisements and 4P key word combinations are most effective on each media player and media genre. The database (server) algorithm would then adjust the key word/phrase weights to more effectively target users with the most effective 4P combination. The marketer can optimize their key words/phrases/rules to focus on media player type advertisements. [Note: the marketer can copy and paste from a different advertising campaign so there is less data entry by the marketer.] It would be beneficial for the marketer to tailor the key words/phrases to the media genre and media player type as this would maximize advertisement effectiveness.

The marketer starts by entering the advertisement type. The three types are 4P contextual, banner (display) and 4P banner (display). The marketer would then select one or several media genres from a list that contains the various media genre types. The marketer would then select the media player that they would have their advertisement displayed on. The players would be ranked according to the priority that the marketer sets up. The marketer has the option of changing the rank and remove media players. For a banner (display) advertisements, the marketer would enter in their banner in the same manner as described earlier in the patent.

As the media player(s) are used, the media player user would be presented with advertisements. The advertisement server algorithm would keep track of which advertisements and 4P key word combinations are most effective on each media player and media genre. The database (server) algorithm would then adjust the key word/phrase weights to more effectively target users with the most effective 4P combination. In this way the web user is served the most effective advertisements. The marketer is presented with reports that show how effective their media player advertisement campaign is progressing and the marketer can adjust their particular key words/phrases/rules and marketing strategy accordingly.

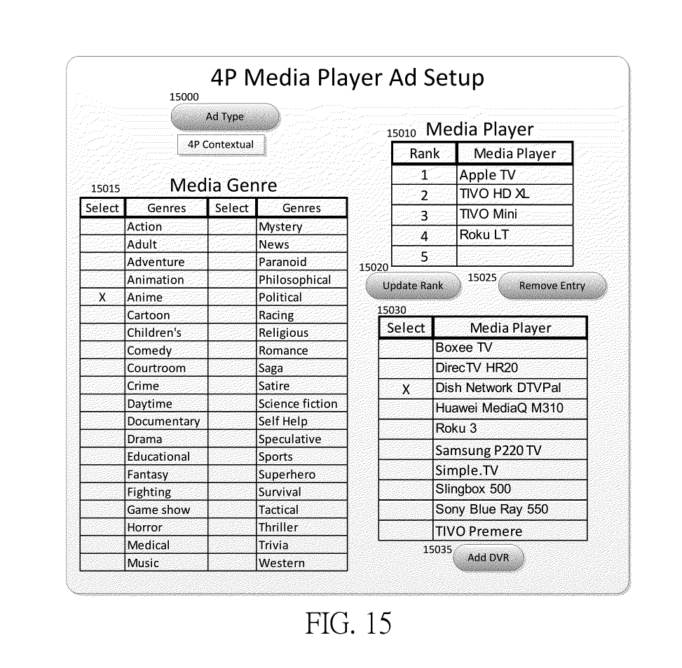

Referring now to FIG. 15, the setup for a 4P Media Player advertisement is presented. This particular example is for an advertisement that would appear before an Anime video/streaming media. The marketer has already entered the information about their advertising campaign and the 4P key words/phrases/linked data/rules. An example of this is in FIG. 1, FIG. 2 and FIG. 3. The marketer starts by selecting the advertisement type (15000) which would be 4P contextual, banner (display) and 4P banner (display). They then enter the media Genre (15015) that they wish their advertisement to appear before, during or after the video/streaming media. The marketer then selects (15035) a media player from a list (15030) of media players that have agreements with the users of this technology. These players would be set up in advance to accept 4P contextual, banner (display) and 4P banner (display) advertisements. These media players would be added to a list (15010) of media players. The marketer would then be able to update their rank (15020) and remove (15025) the media players as necessary.

In another embodiment of the present invention, it is necessary to inform the marketer when their advertisement campaign is not preforming properly as soon as possible. This is accomplished by setting up rules for notifying the marketer when a pre-determined parameter has been exceeded. The marketer would be notified for example if click fraud is occurring or if there are too many instances of bad feedback. The marketer can also set up pre-determined rules to shut down the campaign. This preemptive damage control prevents the marketer from wasting money on an advertising campaign that is not preforming well. Automated damage control also reduces the public relationship damage caused by a misguided advertising campaign. Note that the rules can also be set up to inform the marketer of good news as well but the main emphasis of this feature is to keep damage to a minimal.

The marketer starts by selecting subject of the alert. This includes CPC, CPM, CTR, CTS, ROI, eCPM, TCI, Reach and Frequency, Click Fraud, advertising budget, API interface error good user feedback and bad user feedback. The API interface error applies to the entire campaign and notifies the marketer that the database (server) algorithm cannot get through to the marketer's API, web site or database to extract necessary linked data. The marketer then can select the entire campaign, the individual campaign or and individual advertisement. The marketer is then able to select the value in which the alert or shut down occurs. The types of alert are fax, instant message, text message, recorded phone call message, tweet, automated (computer generated) call, email, direct through the marketers API or to shut down the campaign. Also listed are the existing rules that can be deleted or modified.

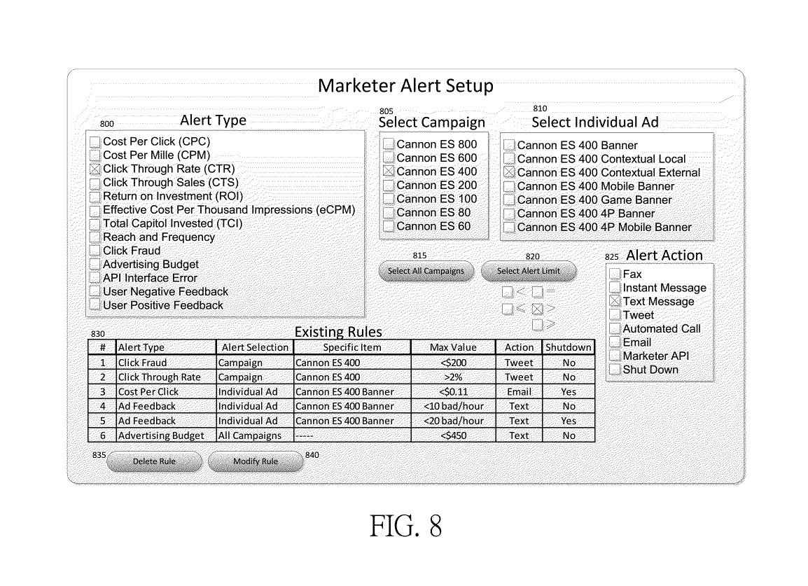

Referring now to FIG. 8, the setup for a 4P Marketer Alert is presented. The marketer starts by selecting the type of alert (800). Each rule can only have one type of alert but the marketer can have multiple rules. For example the marketer could have a tweet occur for a good number of cost per clicks and another rule that shuts down the campaign for a bad number of cost per clicks. The marketer then selects the campaign (805) and/or an individual advertisement (810). The marketer can also select all advertisements in a single campaign, all advertisements in multiple campaigns or all campaigns (815). The marketer then selects the limit for the alert (820) to occur and they select if the alert occurs if it is greater or less than their specified limit. The marketer then selects the action to happen when an alert occurs (825). The alerts are displayed (830) with all the necessary information and the user can delete (835) or modify (840) their existing rules.

In another embodiment of the present invention, the marketer has the ability to manage the all of their advertising campaigns from a single location. This would allow the marketer to select a single campaign or advertisement, edit it, copy it, delete it, activate or deactivate it. By copying then editing a campaign or individual advertisement, the marketer can develop multiple advertisements with minor differences quickly. For example, the marketer could set up an advertising campaign for several different lenses in the same family. Hidden in the background of this application is the ability to copy from one advertisement type to another. For example a 4P contextual advertisement could be copied to a mobile 4P contextual advertisement or a 4P banner (display) advertisement. The marketer would still have to make adjustments and optimizations but most of the information would be present in the copied advertisement and this would save the marketer time by eliminating some re-typing. Another example would be to have the marketer set a seasonal campaign and once the season is over deactivate the campaign and edit/restart it the next season.

In another embodiment of the present invention, the marketer has the ability to generate reports about the progress of their advertisement campaign and the cost effectiveness of their marketing investment. The 17 different reports that the database (server) algorithm can generate are:

1) Account Performance. This report describes the performance of an entire marketers account. This report includes contextual advertisements, external contextual advertisements and banner (display) advertisements on the search engines sites, external sites, mobile devices, games, applications and media players. This report shows the overall performance of all the campaigns and the overall value that the marketer is getting for their investment. The account performance report gives an overall view of all the campaigns and does not show individual advertisement performance [this is accomplished in another report].

The marketer starts by entering in which type of report they are interested in viewing. The reports to choose from are Cost Per Click (CPC), Cost Per Mille [Mille=1000 clicks](CPM), Click Through Rate (CTR), Click Through Success (CTS), Return on Investment (ROI), Effective Cost Per Thousand Impressions (eCPM) and Total Capital Invested (TCI). CPC is the cost of a single click and shows the direct cost of every successful click through. CPM is an industry metric used to contract and pay for display advertisements that are served to visitors. CTR is the number of clicks an advertisement unit receives divided by the number of times it is shown, expressed as a percentage. CTS is a newly developed term, it takes the amount of click through to the marketers site and divides this by the number of sales that the marker made expressed as a percentage. This relates to how successful an advertisement is at conveying what the marketer's site has to offer. ROI is the ratio of money gained or lost (whether realized or unrealized) on an investment relative to the amount of money invested expressed as a percentage. The database (server) algorithm has the additional ability of relating ROI to the actual income that the marketer realizes. This is done by manual entry or gathering the data through the marketers API. eCPM is calculated by dividing the total earnings from an advertisement by its impressions in thousands. This way the marketer can directly see how their advertisement spending relates to their profit. TCI is the amount of money spent without any advertisement performance. The marketer then selects the dates of the analysis to develop a report. The marketer can have an instant snapshot of the last hour or a historical analysis showing up to years' worth of information.

The database (server) algorithm does not know if a click through lead to a sale at the marketers. To solve this issue, the marketer is prompted to manually enter in their monthly/quarterly sales to calculate Click Through Sales. In addition, this data can be linked through the marketers API so that manual entry is not necessary. With this information, the database (server) algorithm knows how many click through were made to the marketer's site for a given period and the number of sales to the marketers site. This report will then show the marketer specifically how successful they are.

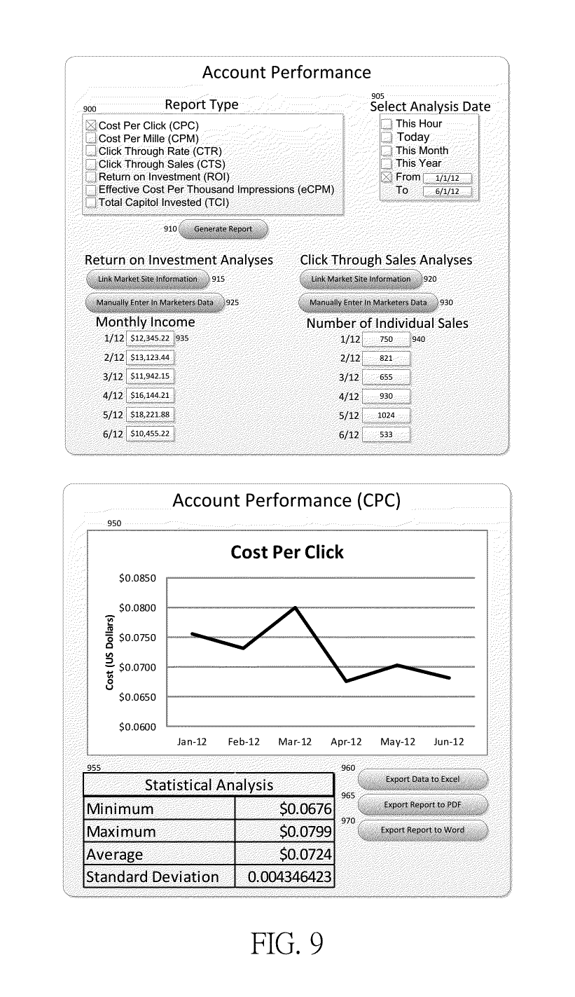

Referring now to FIG. 9, an example entry for account performance is shown. The marketer first selects the report type. Their choices are one or all of CPC, CPM, CTR, CTS, ROI, eCPM, and TCI (900). They then select the time period of when they want to see the report (905). In order to fully realize the return on investment, they can link their own income data (915) or manually enter in their data (925). The data is displayed for reference (935). In order to complete the click through sales analysis, they can link their own sales data (920) or manually enter in their data (930). The data is displayed for reference (940). When they are ready, they generate the report (910).

In this example case a graph of the Cost Per Click is displayed (950). The graph displays the account performance by date and in this cost per click in dollars. This gives the marketer a graphical representation of how successful the advertisement campaign is by cost per click as it is recorded over time. The statistical analysis (955) of this same time period is displayed with the maximum, minimum, average and standard deviation. The marketer has the ability to export the data to Excel (960), PDF (965) or to a word file (970).

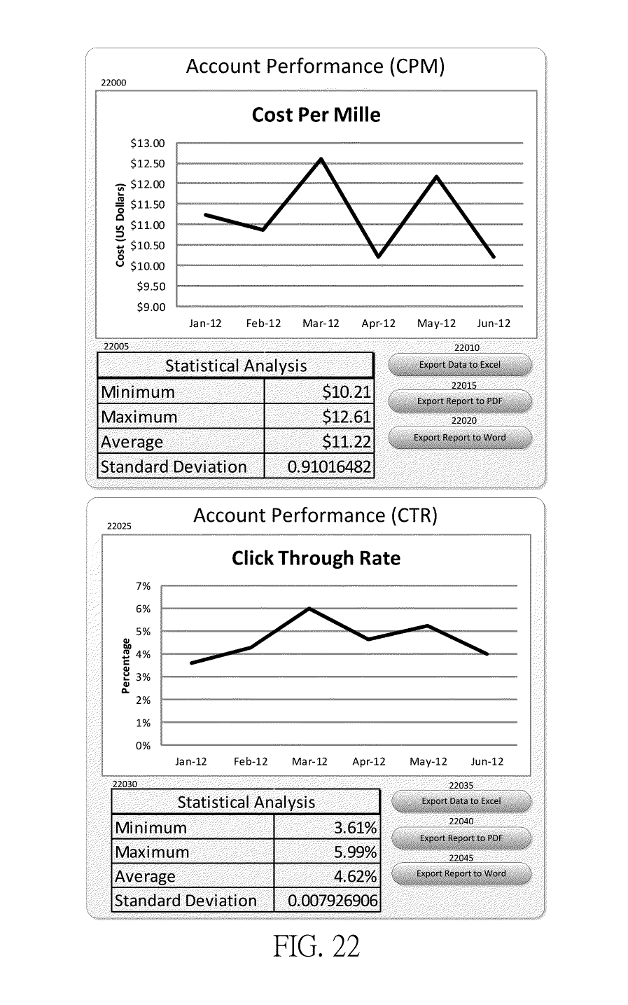

Referring now to FIG. 22, are two example graphs/statistics for account performance is shown. In this first example case a graph of the Cost Per Mille is 20 displayed (22000). The graph displays the account performance by date and in this cost per mille in dollars. This gives the marketer a graphical representation of how successful the advertisement campaign is by analyzing cost per mille as it is recorded over time. The statistical analysis (22005) of this same time period is displayed with the maximum, minimum, average and standard deviation. The marketer has the ability to export the data to Excel (22010), PDF (22015) or to a word file (22020).

In this second example case a graph of the Click Through Rate is displayed (22025). The graph displays the account performance by date and in this click through rate in percentage. This gives the marketer a graphical representation of how successful the advertisement campaign is by analyzing click through rate as it is recorded over time. The statistical analysis (22030) of this same time period is displayed with the maximum, minimum, average and standard deviation. The marketer has the ability to export the data to Excel (22035), PDF (22040) or to a word file (22045).

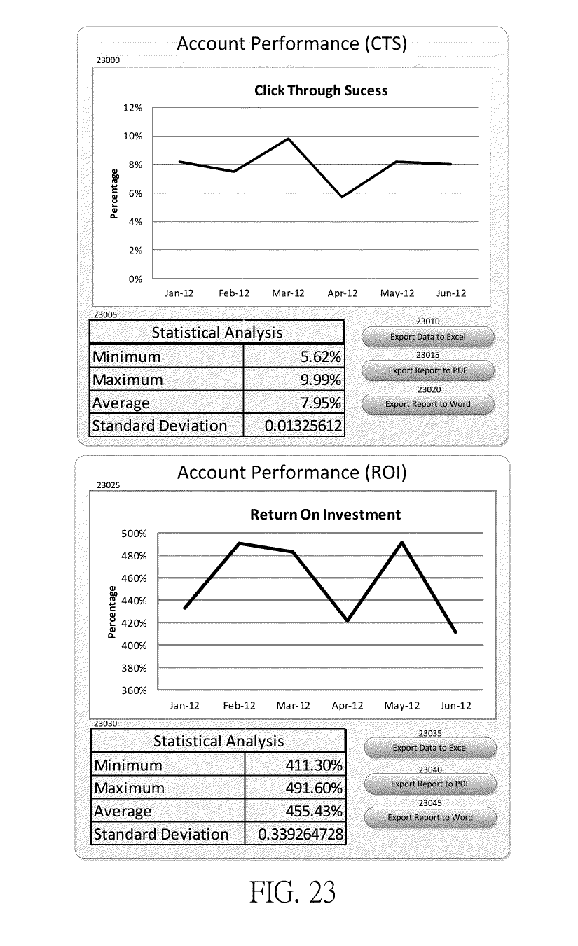

Referring now to FIG. 23, are two example graphs/statistics for account performance is shown. In this first example case a graph of the Click Through Success is displayed (23000). The graph displays the account performance by date and in this click through success in percentage. This gives the marketer a graphical representation of how successful the advertisement campaign is by analyzing click through success as it is recorded over time. The statistical analysis (23005) of this same time period is displayed with the maximum, minimum, average and standard deviation. The marketer has the ability to export the data to Excel (23010), PDF (23015) or to a word file (23020). In this second example case a graph of the Return On Investment is displayed (23025). The graph displays the account performance by date and in this return on investment in percentage. This gives the marketer a graphical representation of how successful the advertisement campaign is by analyzing return on investment as it is recorded over time. The statistical analysis (23030) of this same time period is displayed with the maximum, minimum, average and standard deviation. The marketer has the ability to export the data to Excel (23035), PDF (23040) or to a word file (23045).

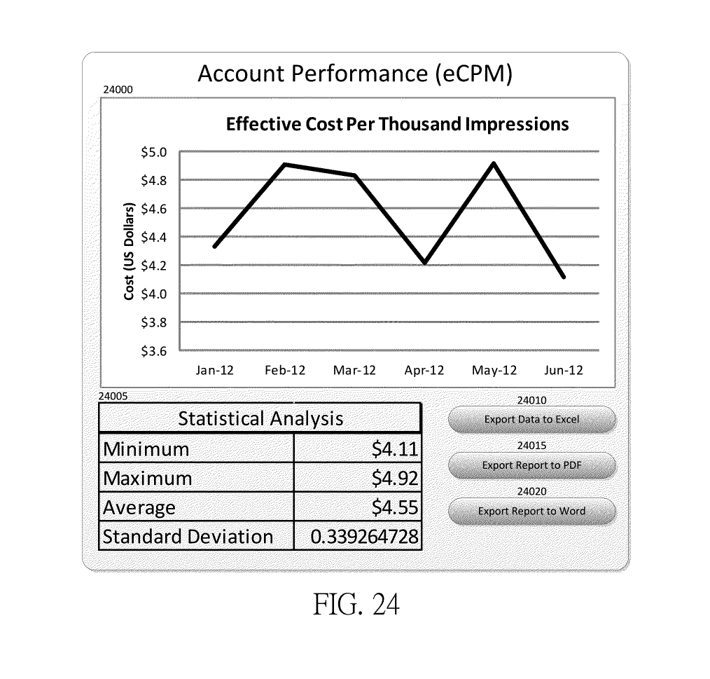

Referring now to FIG. 24, are an example of a graphs/statistics for account performance is shown. In this example case a graph of the Effective Cost Per thousand Impressions is displayed (24000). The graph displays the account performance by date and in this effective cost per thousand impressions in dollars. This gives the marketer a graphical representation of how successful the advertisement campaign is by analyzing effective cost per thousand impressions as it is recorded over time. The statistical analysis (24005) of this same time period is displayed with the maximum, minimum, average and standard deviation. The marketer has the ability to export the data to Excel (24010), PDF (24015) or to a word file (24020).

2) Campaign Performance. This report describes the performance of a single campaign that the marketer has with users of this technology. The report appearance is the same as the overall account performance except a single campaign is singled out for analysis. The marketer has a list of their individual campaigns that they can select for analysis. In addition, the marketer is able to enter in sales/income information for an individual product/service to display ROI or CTS on this individual campaign.
3) Advertisement Group Performance. This report describes the performance of multiple 5 campaigns or multiple products/services that the marketer has with the users of this technology and allows them to compare results. The appearances of the reports generated are similar to overall account performance except that multiple campaigns can be selected for comparison analysis. In addition, the marketer is able to enter in sales/income information for an advertisement group product/service to display ROI or CTS on this advertisement group.
4) Individual Advertisement Performance. This report describes the performance of a single advertisement that the marketer has with the users of this technology. The appearance of this report is similar to overall account performance except that a single advertisement is analyzed. In addition, the marketer is able to enter in sales/income information for an individual product/service to display ROI or CTS on this individual advertisement.
5) Keyword Performance. This report describes the performance of individual key words associated with a single advertisement. The marketer is able to choose a campaign then a single advertisement then the keyword type for that advertisement and then the individual keywords. The marketer may enter their own income and sales for this time period to get the ROI and click through sales analysis. The result of this report is a graphical and statistical analysis [that may be exported] of CPC, CPM, CTR, CTS, ROI, eCPM, and TCI over the time that the marketer specifies. An added feature of the report is the ability to update the keywords biased how the marketer interoperates the report.

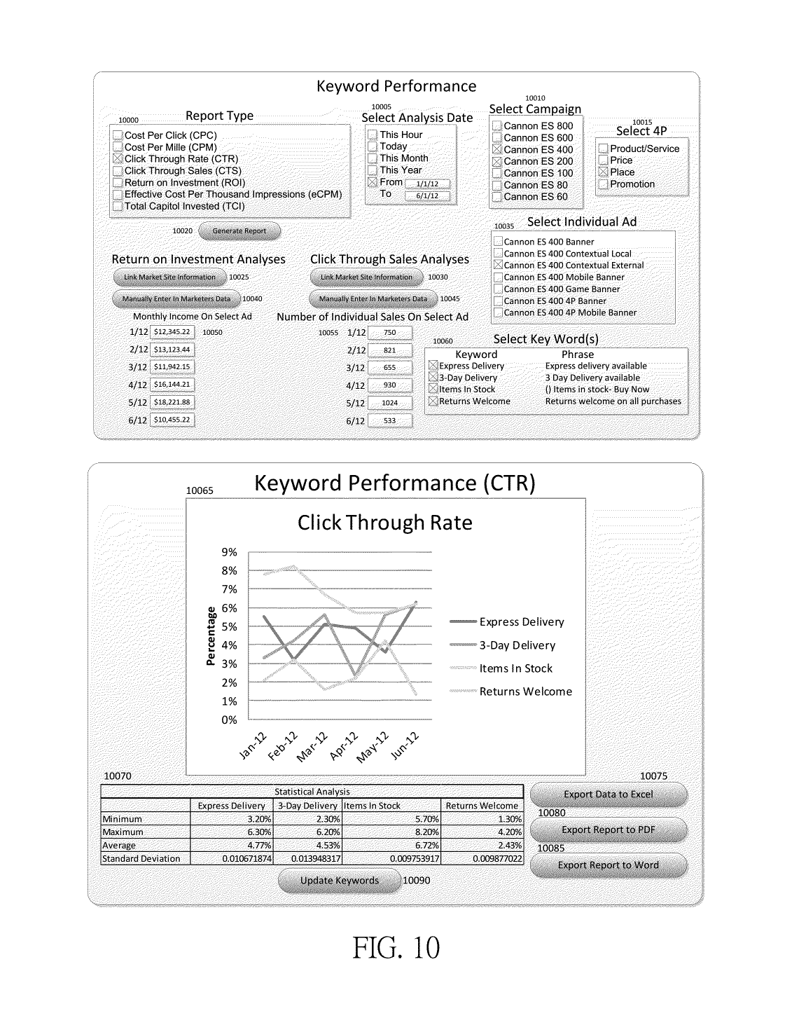

Referring now to FIG. 10, an example entry for keyword performance is shown. The marketer first selects the report type. Their choices are one or all of CPC, CPM, CTR, CTS, ROI, eCPM, and TCI (10000). They then select the time period of when they want to see the report (10005). They then select the campaign (10010) and individual advertisement (10035). In order to fully realize the return on investment, they can link their own income data (10025) or manually enter in their data (10040). The data is displayed for reference (10050). In order to complete the click through sales analysis, they can link their own sales data (10030) or manually enter in their data (10045). The data is displayed for reference (10045). The marketer then selects the key words/phrases (10015) from a list (10060) of 4P's used in their advertisements. When the marketer is ready, they generate the report (10020).

In this example case a graph of the Click Through Rate is displayed (10065). The graph displays the Click Through Rate for several key words by date in percentage. This gives the marketer a graphical representation of how successful each key word is [in this example with click through rate]. The statistical analysis (10070) of this same time period is displayed of each item selected with the maximum, minimum, average and standard deviation. The marketer has the ability to export the data to Excel (10075), PDF (10080) or to a word file (10090). The marketer can go directly to the key word ranking and update it based on the results of the report (10090).

As a result of this analysis, it is clear that the key word “Express Delivery” has a high click through rate and “Returns Welcome” has a low click through rate. The marketer could raise the rank of Express Delivery to better maximize that marketing advantage. The marketer could also adjust the key phrase for “Returns Welcome” to improve marketing the performance of that key word/phrase.

6) Game Performance. This report describes the performance of advertisements inside of games. The marketer is able to choose a game advertising campaign then a one or may advertisements from that campaign. The marketer may enter their own income/sales for this time period to get the ROI and click through sales analysis. The result of this report is a graphical and statistical analysis [that may be exported] of CPC, CPM, CTR, CTS, ROI, eCPM, and TCI over the time that the marketer specifies. With this information, the marketer can evaluate how effective their game campaign and go directly to the games list and make changes based on the generated report.

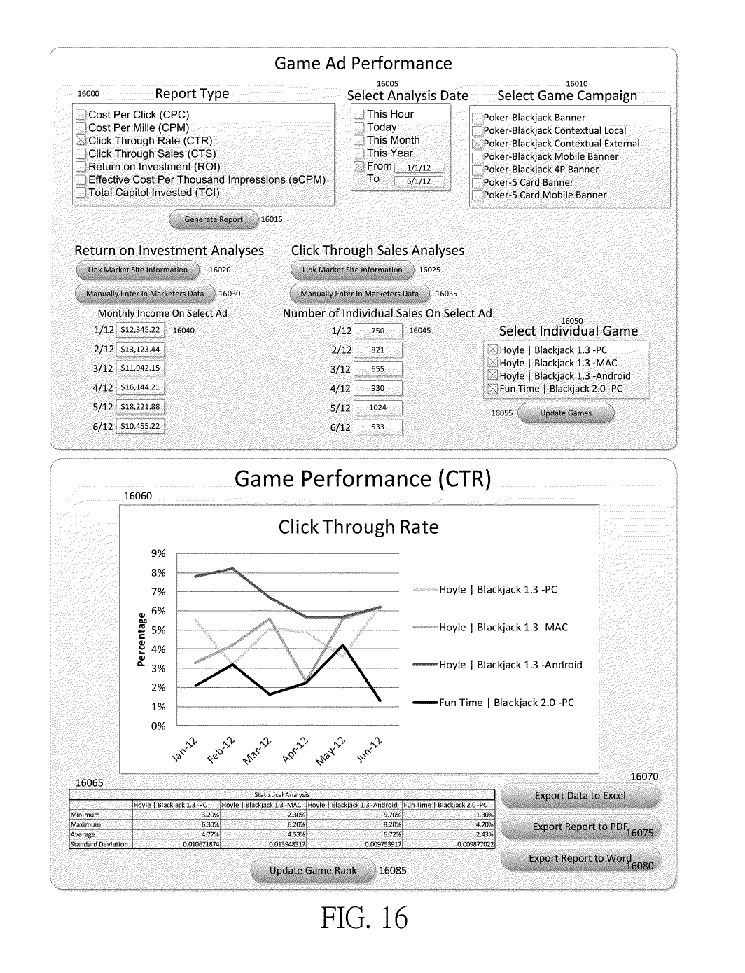

Referring now to FIG. 16, an example entry for game performance is shown. The marketer first selects the report type. Their choices are one or all of CPC, CPM, CTR, CTS, ROI, eCPM, and TCI (16000). They then select the time period of when they want to see the report (16005). They then select the game advertising campaign (16010). In order to fully realize the return on investment, they can link their own income data (16020) or manually enter in their data (16030). The data is displayed for reference (16040). In order to complete the click through sales analysis, they can link their own sales data (16025) or manually enter in their data (16035). The data is displayed for reference (16045). The marketer then selects the key individual game (16050) from a list. When the marketer is ready, they generate the report (16015). After the report is analyzed, the marketer may go and update (16055) their game campaign based on the results of the analysis.

In this example case a graph of the Click Through Rate is displayed (16060). The graph displays the Click Through Rate for several games by date in percentage. This gives the marketer a graphical representation of how successful each game preforms [in this example with click through rate]. The statistical analysis (16065) of this same time period is displayed of each item selected with the maximum, minimum, average and standard deviation. The marketer has the ability to export the data to Excel (16070), PDF (16075) or to a word file (16080). The marketer can go directly to the game ranking and update it based on the results of the report (16085).

As a result of this analysis, it is clear that the game “Hoyle Blackjack 1.3-MAC” has a high click through rate and “Fun Time Blackjack 2.0” has a low click through rate. The marketer could then raise the rank of Hoyle Blackjack 1.3-MAC to better maximize that marketing advantage. The marketer could also adjust the key words, lower the rank or eliminate Fun Time Blackjack 2.0 [and possibly select a new game] to improve marketing performance.

7) Application Performance. This report describes the performance of advertisements within applications. The marketer is able to choose an application advertising campaign then a one or may advertisements from that campaign to analyze. The marketer may enter their own income/sales for this time period to get the ROI and click through sales analysis. The result of this report is a graphical and statistical analysis [that may be exported] of CPC, CPM, CTR, CTS, ROI, eCPM, and TCI over the time that the marketer specifies. With this information, the marketer can evaluate how effective their application campaign is and go directly to the applications list and make changes based on the generated report.

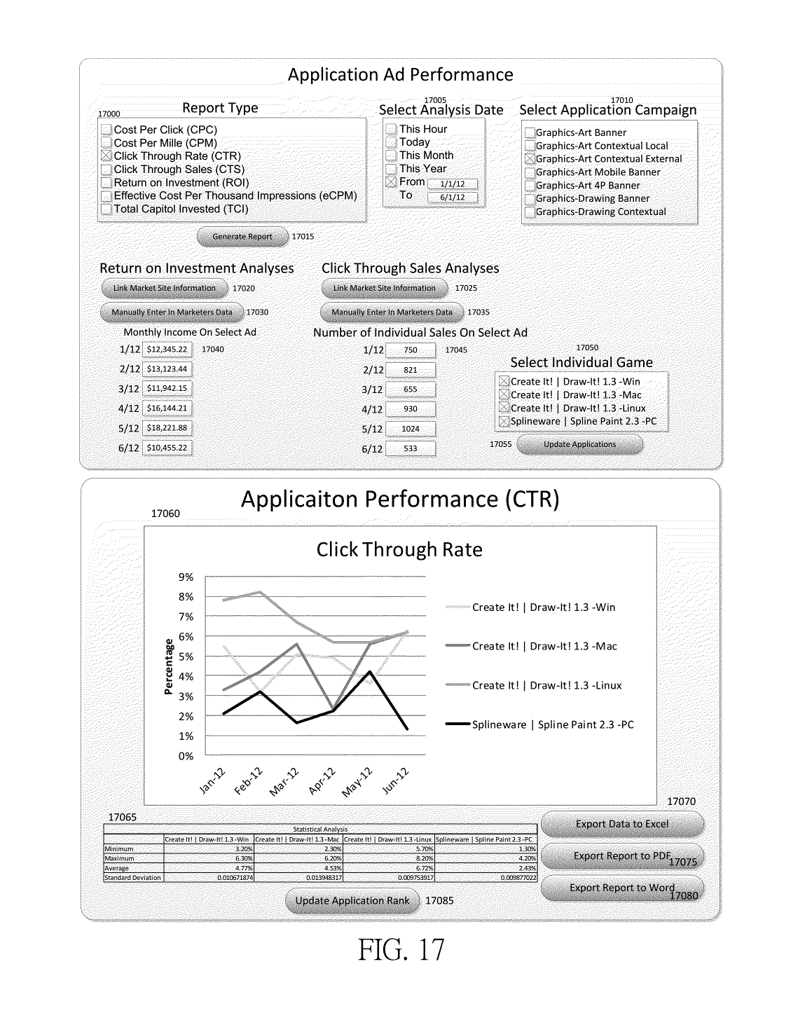

Referring now to FIG. 17, an example entry for computer application performance is shown. The marketer first selects the report type. Their choices are one or all of CPC, CPM, CTR, CTS, ROI, eCPM, and TCI (17000). They then select the time period of when they want to see the report (17005). They then select the application advertising campaign (17010). In order to fully realize the return on investment, they can link their own income data (17020) or manually enter in their data (17030). The data is displayed for reference (17040). In order to complete the click through sales analysis, they can link their own sales data (17025) or manually enter in their data (17035). The data is displayed for reference (17045). The marketer then selects the key individual applications (17050) from a list. When the marketer is ready, they generate the report (17015). After the report is analyzed, the marketer may go and update (17055) their application campaign based on the results of the analysis.

In this example case a graph of the Click Through Rate is displayed (17060). The graph displays the Click Through Rate for several applications by date in percentage. This gives the marketer a graphical representation of how successful each application preforms [in this example with click through rate]. The statistical analysis (17065) of this same time period is displayed of each item selected with the maximum, minimum, average and standard deviation. The marketer has the ability to export the data to Excel (17070), PDF (17075) or to a word file (17080). The marketer can go directly to the application ranking and update it based on the results of the report (17085).

As a result of this analysis, it is clear that the application “Create IT! Draw-It! 1.3 MAC” has a high click through rate and “Splineware Spline Paint 2.3-PC” has a low click through rate. The marketer could then raise the rank of Create IT! Draw-It! 1.3 MAC to better maximize that marketing advantage. The marketer could also adjust the key words, lower the rank or eliminate Splineware Spline Paint 2.3-PC [and possibly select a new application] to improve marketing performance.

8) Media Player Performance. This report describes the performance of media player advertisements. The marketer is able to choose an advertising campaign then a one or may advertisements from that campaign to analyze. The marketer may enter their own income/sales for this time period to get the ROI and click through sales analysis. The result of this report is a graphical and statistical analysis [that may be exported] of CPC, CPM, CTR, CTS, ROI, eCPM, and TCI over the time that the marketer specifies. With this information, the marketer can evaluate how effective their media player campaign is and go directly to the media player list and make changes based on the generated report.

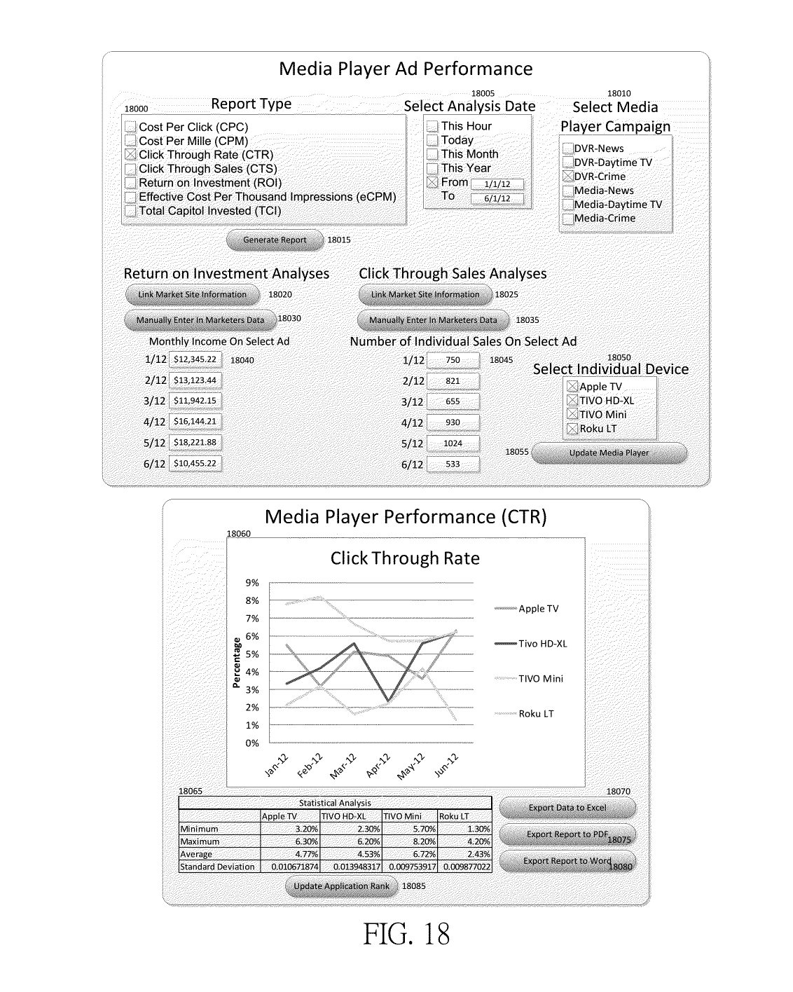

Referring now to FIG. 18, an example entry for media player performance is shown. The marketer first selects the report type. Their choices are one or all of CPC, CPM, CTR, CTS, ROI, eCPM, and TCI (18000). They then select the time period of when they want to see the report (18005). They then select the media player advertising campaign (18010). In order to fully realize the return on investment, they can link their own income data (18020) or manually enter in their data (18030). The data is displayed for reference (18040). In order to complete the click through sales analysis, they can link their own sales data (18025) or manually enter in their data (18035). The data is displayed for reference (18045). The marketer then selects the key individual media player device (18050) from a list. When the marketer is ready, they generate the report (18015). After the report is analyzed, the marketer may go and update (18055) their media player campaign based on the results of the analysis.

In this example case a graph of the Click Through Rate is displayed (18060). The graph displays the Click Through Rate for several media players by date in percentage. This gives the marketer a graphical representation of how successful each media player preforms [in this example with click through rate]. The statistical analysis (18065) of this same time period is displayed of each item selected with the maximum, minimum, average and standard deviation. The marketer has the ability to export the data to Excel (18070), PDF (18075) or to a word file (18080). The marketer can go directly to the media player ranking and update it based on the results of the report (18085). As a result of this analysis, it is clear that the media player “Tivo HD-XL” has a high click through rate and “Roku LT” has a low click through rate. The marketer could then raise the rank of Tivo HD-XL to better maximize that marketing advantage. The marketer could also adjust the key words, lower the rank or eliminate Roku LT [and possibly select a new media player] to improve marketing performance.

9) URL Performance. This report describes the performance of the individual URL that the advertisement is served to. The marketer has previously chosen external web sites to serve their 4P external contextual advertisement and/or banner (display) and or 4P banner (display) advertisements to. The result of this report is a graphical and statistical analysis [that may be exported] of CPC, CPM, CTR, CTS, ROI, eCPM, and TCI over the time that the marketer specifies. This report will allow the marketer to compare the performance of each URL that their advertisements are served to. The marketer has the ability to choose one or several sites to compare performance. An added feature of the report is the ability to change the URL's biased on the report interpretation.

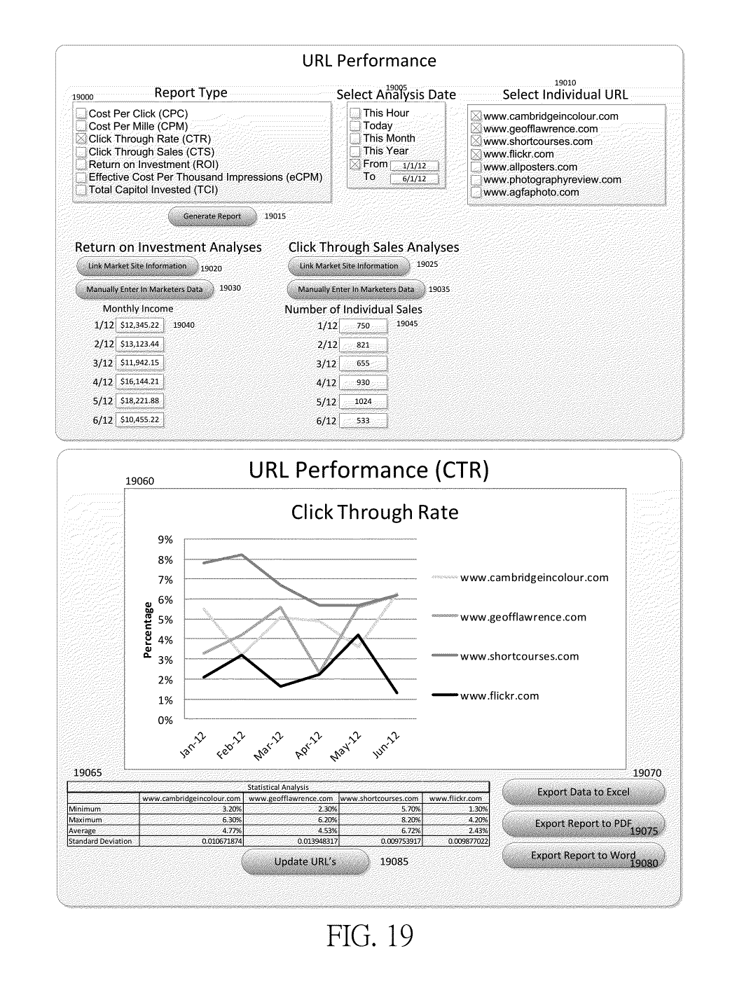

Referring now to FIG. 19, an example entry for URL performance is shown. The marketer first selects the report type. Their choices are one or all of CPC, CPM, CTR, CTS, ROI, eCPM, and TCI (19000). They then select the time period of when they want to see the report (19005). They then select the URL (19010). In order to fully realize the return on investment, they can link their own income data (19020) or manually enter in their data (19030). The data is displayed for reference (19040). In order to complete the click through sales analysis, they can link their own sales data (19025) or manually enter in their data (19035). The data is displayed for reference (19045). When the marketer is ready, they generate the report (19015).

In this example case a graph of the Click Through Rate is displayed (19060). The graph displays the Click Through Rate for several URL's by date in percentage. This gives the marketer a graphical representation of how successful each URL preforms [in this example with click through rate]. The statistical analysis (19065) of this same time period is displayed of each item selected with the maximum, minimum, average and standard deviation. The marketer has the ability to export the data to Excel (19070), PDF (19075) or to a word file (19080). The marketer can go directly to the URL ranking and update it based on the results of the report (19085).

As a result of this analysis, it is clear that the URL “www.geofflawrence.com” has a high click through rate and “www.flicker.com” has a low click through rate. The marketer could then raise the rank of www.geofflawrence.com to better maximize that marketing advantage. The marketer could also adjust the key words, lower the rank or eliminate www.geofflawrence.com [and possibly select a new URL] to improve marketing performance.

10) Demographic Performance. This report describes how effective the advertising campaigns are on the different demographics. The marketer has the ability to choose a campaign or a specific advertisement to generate a report. They then choose the demographic to analyze. The choice is age and gender. Age is broken down into ten year blocks. The demographic information is gathered by cookie data and other databases. The result of this report is a graphical and statistical analysis [that may be exported] of CPC, CPM, CTR, CTS, ROI, eCPM, and TCI over the time that the marketer specifies. The reason for studying demographics is to see what demographic is interested in the marketers advertisement. Marketers can target their advertisements to a specific demographic and with this report see if their advertisement is on target. For example if a music product for targeted toward teenage girls and the advertisements are being presented to older men, the marketer would adjust their campaign to correct this by selecting different sites to serve the advertisement or adjusting key words/phrases.

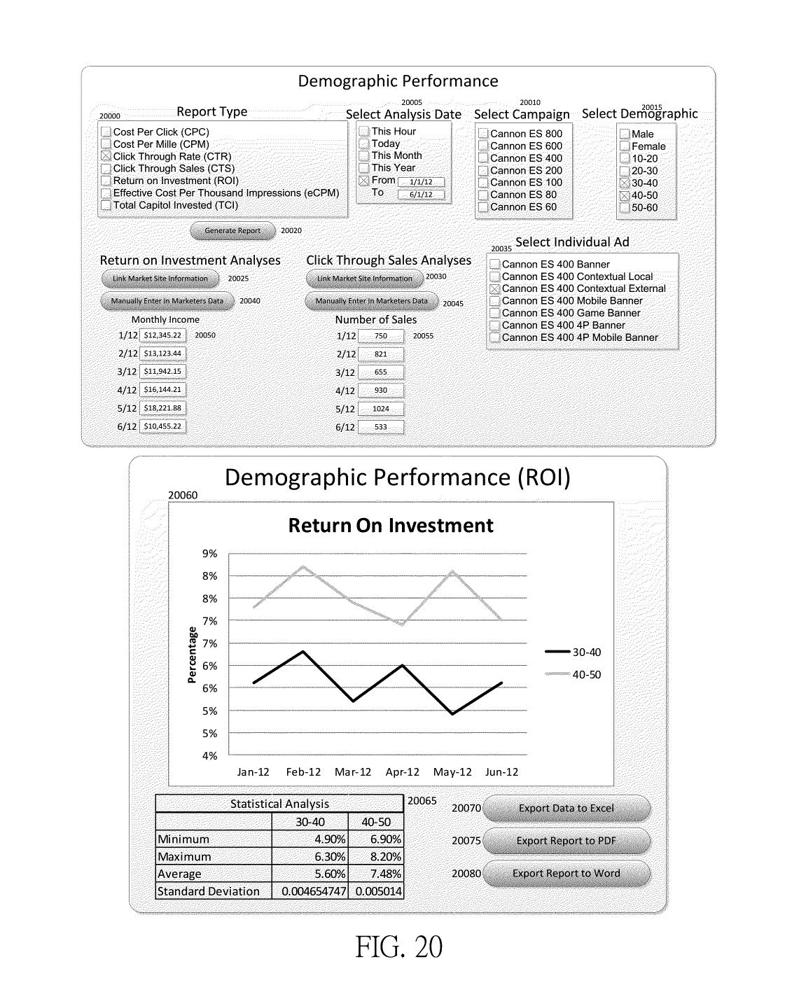

Referring now to FIG. 20, an example entry for demographic performance is shown. The marketer first selects the report type. Their choices are one or all of CPC, CPM, CTR, CTS, ROI, eCPM, and TCI (20000). They then select the time period of when they want to see the report (20005). They then select the advertising campaign (20010). The marketer then selects the demographic (20015). The marketer then selects the individual advertisement (20035). Note that the marketer can select the entire campaign and analyze the demographics of that. In order to fully realize the return on investment, they can link their own income data (20022) or manually enter in their data (20040). The data is displayed for reference (20050). In order to complete the click through sales analysis, they can link their own sales data (20030) or manually enter in their data (20045). The data is displayed for reference (20055). When the marketer is ready, they generate the report (20020)

In this example case a graph of the Click Through Rate is displayed (20060). The graph displays the Click Through Rate for the 30-40 and 40-50 demographic [in this example] by date in percentage. This gives the marketer a graphical representation of how successful each demographic is [in this example with click through rate]. The statistical analysis (20065) of this same time period is displayed of each item selected with the maximum, minimum, average and standard deviation. The marketer has the ability to export the data to Excel (20070), PDF (20075) or to a word file (20080).

As a result of this analysis, it is clear that the demographic of 40-50 year olds people have a higher click through rate and the demographic of 30-40 year olds have a lower click through rate. The purpose of this analysis is to ensure the marketer they their advertising campaign is hitting the marketers desired demographic. Using this demographic analysis information the marketer can adjust their key words/phrase to better target their demographic.

11) Geographic Performance. This report describes performance over the geographical region that the advertisement is that is being served. The marketer has the ability to choose a campaign or a specific advertisement. The marketer then chooses the specific geographic region to analyze. The choice is city, zip code or state. The result of this report is a graphical and statistical analysis [that may be exported] of CPC, CPM, CTR, CTS, ROI, eCPM, and TCI over the time that the marketer specifies. The graphical report can also be in a map format showing dots [representing graphical location] of where the users were located when they viewed an advertisement.

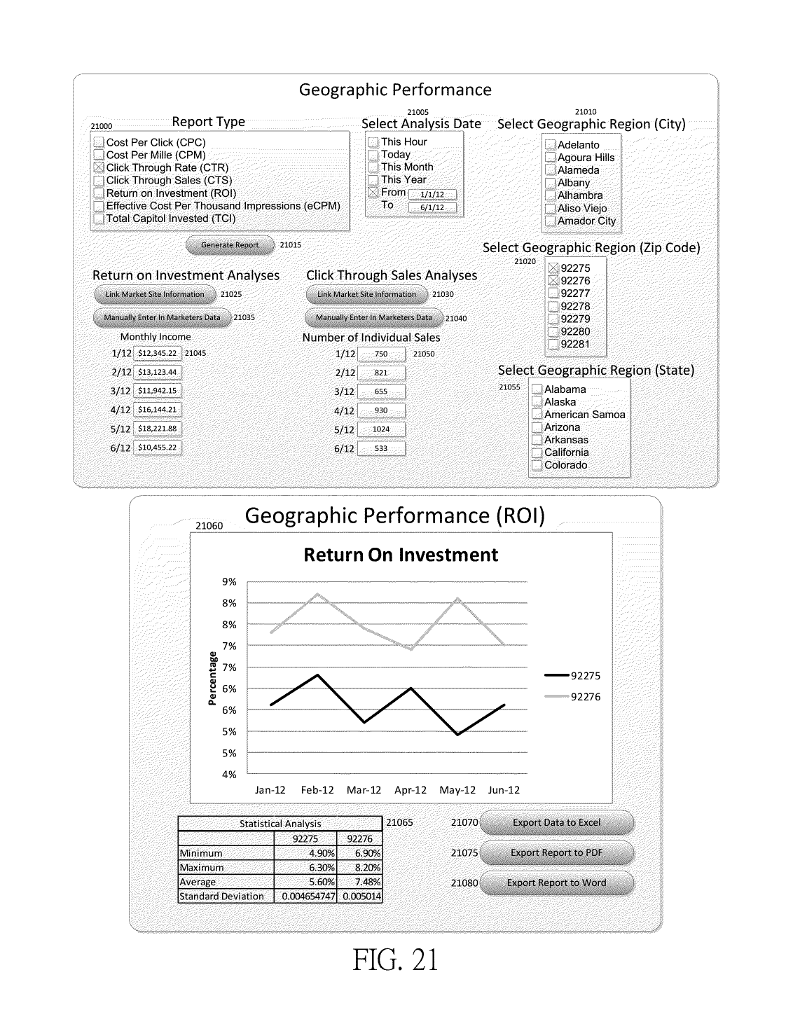

Referring now to FIG. 21, an example entry for geographic performance is shown. The marketer first selects the report type. Their choices are one or all of CPC, CPM, CTR, CTS, ROI, cCPM, and TCI (21000). They then select the time period of when they want to see the report (21005). They then select the geographic region (21010) (21020) (21055) to analyze. Not shown in this example is the ability to select a radius like in FIG. 1 (125). In order to fully realize the return on investment, they can link their own income data (21025) or manually enter in their data (21035). The data is displayed for reference (21045). In order to complete the click through sales analysis, they can link their own sales data (21030) or manually enter in their data (21040). The data is displayed for reference (21050). When the marketer is ready, they generate the report (21015).

In this example case a graph of the Click Through Rate is displayed (21060). The graph displays the Click Through Rate for several two zip codes by date in percentage. This gives the marketer a graphical representation of how successful each zip code preforms [in this example with click through rate]. The statistical analysis (21065) of this same time period is displayed of each item selected with the maximum, minimum, average and standard deviation. The marketer has the ability to export the data to Excel (21070), PDF (21075) or to a word file (21080).

As a result of this analysis, it is clear that the zip code of 92276 has a higher click through rate and the zip code 92275 has a lower click through rate. The purpose of this analysis is to ensure the marketer they their marketing campaign is successful in each geographic region that the campaign operates. Using this geographic analysis information the marketer can adjust their key words/phrase to better target their geographic region.

12) Search Query Performance. This report displays the web user search queries that triggered an advertisement to be served. The marketer has the ability to choose a campaign or a specific advertisement. The database (server) algorithm then can generate a report to shows the queries, date, time and if there was a successful click through. The result of this report is a detailed listing of the search term, the date/time and if it was a successful click through that may be exported.

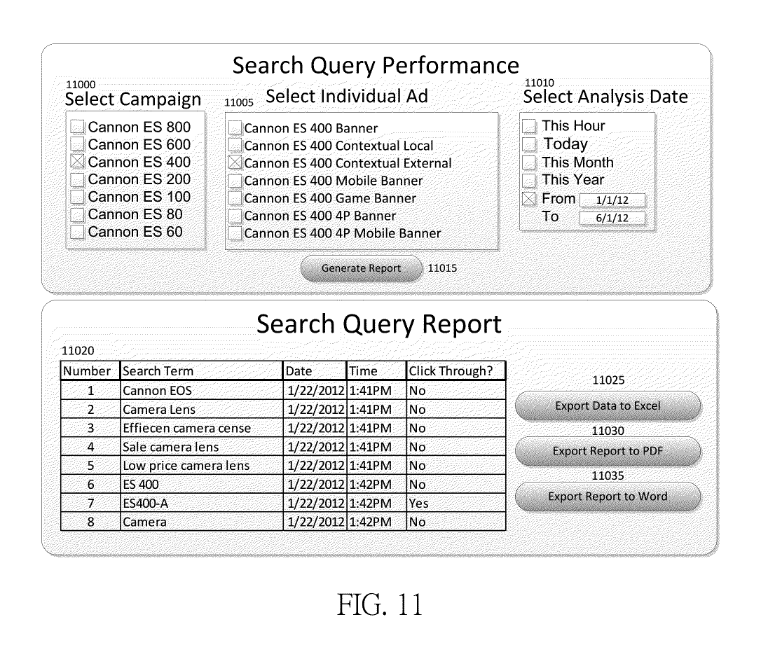

Referring now to FIG. 11, an example entry for search query performance is shown. The marketer starts by selecting the campaign (11000), individual advertisement (11005) and the analysis date (11010). They then generate the report 11015). The results are displayed (11020) detailed listing of the search term, the date/time and if it was a successful click through. The marketer has the ability to export the data to Excel (11025), PDF (11030) or to a word file (11035).

Using this data, the marketer can see what searches triggered their advertisement to be served to a user. The marketer can gain insight as to what the users are searching for and adjust their key words more accurately attract users to their advertisements. The 30 marketer may also adjust negative key words to better prevent unwelcome users to their advertisements based on the searches that triggered their advertisements. In this particular example, the marketer can see that search ES400-A had a successful click through. The marketer may wish to add “ES400-A” as part of a product key word if this is not already present.

13) Placement Performance. This report describes the performance of the campaign or individual advertisement as it relates to the three major search engines. The marketer is able to choose a single campaign or advertisement then compare the performance between the search engines. The result of this report is a graphical and statistical analysis [that may be exported] of CPC, CPM, CTR, CTS, ROI, eCPM, and TCI over the time that the marketer specifies.
14) Reach and Frequency Performance. This series of reports describes the reach and frequency performance of the campaign or individual advertisement. Reach is the amount of visitors that view the advertisement. Frequency is the number of times that an individual web user has seen the specific advertisement. This information is expressed as a percentage ratio. The marketer is able to choose a single campaign or advertisement then show the result. The result of this report is a graphical and statistical analysis of the reach and frequency that may be exported over the time that the marketer specifies.

Referring now to FIG. 29, an example entry for Reach and Frequency Performance is shown. The marketer first selects the report campaign they wish to analyze (29000). The marketer may or may not then select the individual campaign (29005). The marketer then selects the time period of when they want to see the report (29010). When the marketer is ready, they generate the report (29015).

In this Reach and Frequency Performance example graph of an individual advertisement is shown (29020). The graph displays the reach and frequency performance by date in percentage. This gives the marketer a graphical representation of how successful there advertisement is in terms of repeat customers. The statistical analysis (29025) of this same time period is displayed with the maximum, minimum, average and standard deviation. The marketer has the ability to export the data to Excel 30 (29030), PDF (29035) or to a word file (29040).

As a result of this analysis, it is clear that the market had some initial success but there campaign is starting to flatten out. Using this geographic analysis information the marketer can adjust their target site to get more users to have return visits.

15) Click Fraud Analysis. The competitors to a marketer have the ability to drain money from a marketer's advertising campaign by initiating click fraud. The competitor can have computer bots or real people making queries that simulate a legitimate web user making a click-through. The result of this is that the marketer spends their marketing money on the phantom clicks and not on real [potential] customers. This report analyses the data to reveal the amount [if any] click fraud and provide tools for resolving the issue. The marketer runs the report on a marketing campaign or on an individual advertisement. The result of the click fraud report showing the frequency of individual users. It would be clear that a click fraud user would have a higher frequency of visits. These users can be identified then excluded [blocked] from making click trough's and thus reducing the click fraud. These users can also be reported so that they do not have a future effect on the marketer or affect other marketers.

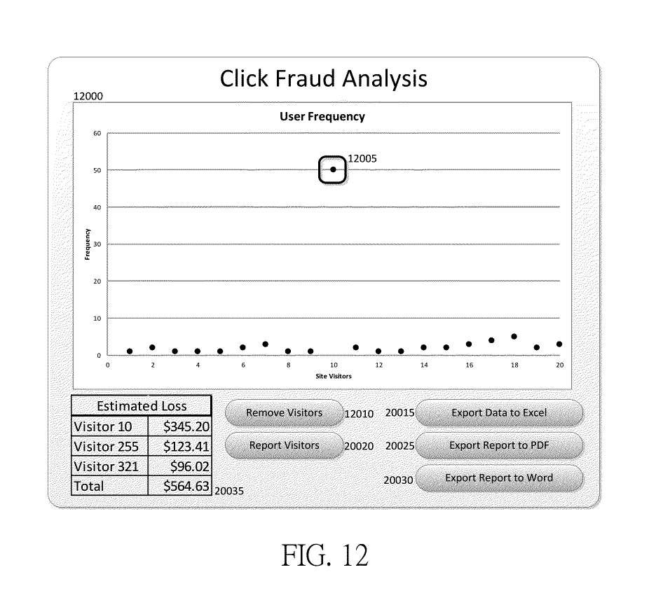

Referring now to FIG. 12 a click fraud analysis report is presented. The graph showing users versus the frequency at which they visited the market site is shown (12000). Normally web users would only visit a site a few times. A web user making multiple triggers to an advertisement is not likely to be making legitimate use of the site (12005) and is identified by the database (server) algorithm. This user can be removed from future interaction with this marketer (12010) and reported as somebody initiating click fraud (12020). The impact of the click fraud is displayed by visitor number and the total financial impact displayed (12035). The marketer is able to have the ability to export the data to Excel (12015), PDF (12025) or to a word file (12030). What is not shown in this simplified example report is the ability to identify the user so that the marketer may have a clue as to who is perpetrating the click fraud. This would be done by investigating the URL, cookie and other information recorded by the database (server) algorithm.

16) Direct Feedback Analysis. Normally a marketer would pay a survey firm to conduct an extensive campaign to evaluate an advertisement. This effort is expensive, time consuming, not up to date and sometime inaccurate. the database (server) algorithm has a direct advertisement feature that allows web users provide direct accurate feedback and the marketer gets this information fast and for free. This is accomplished by a small roll-over triggered by link next to each advertisement or a larger roll-over that captures more detail. When clicked the web user has the ability to leave feedback for the marketer. Details are also recorded about the particular advertisement, search, user information, date/time, search history and other information on the page being displayed.

Additionally a more comprehensive system of feedback is available where the user has more questions and they can leave details about themselves. This gives the marketer more information on why the user liked/disliked the advertisement, and more about themselves (demographics) and suggestions for improvement. This information is given to the marketer so that that can adjust their campaigns to have better results. This information is also used by the users of this technology to adjust key word/phrase weights to encourage advertisements with good feedback and discourage advertisements with bad feedback. In addition an advertisement may be unintentionally offensive or mis-targeted. Quick direct feedback prevents the marketer from alienating their potential customers and reduces public relationship disasters. This series of reports describes the performance of multiple campaigns that the marketer has with the users of this technology with respect to the direct feedback that web users gave to their advertisements. The marketer can select a single campaign or multiple campaigns and get a graphical report of the direct feedback that can be exported. They can also view and export the comments that the web user has recorded. The result is that the marketer has a real time insight into their audience on how effective their marketing efforts are.

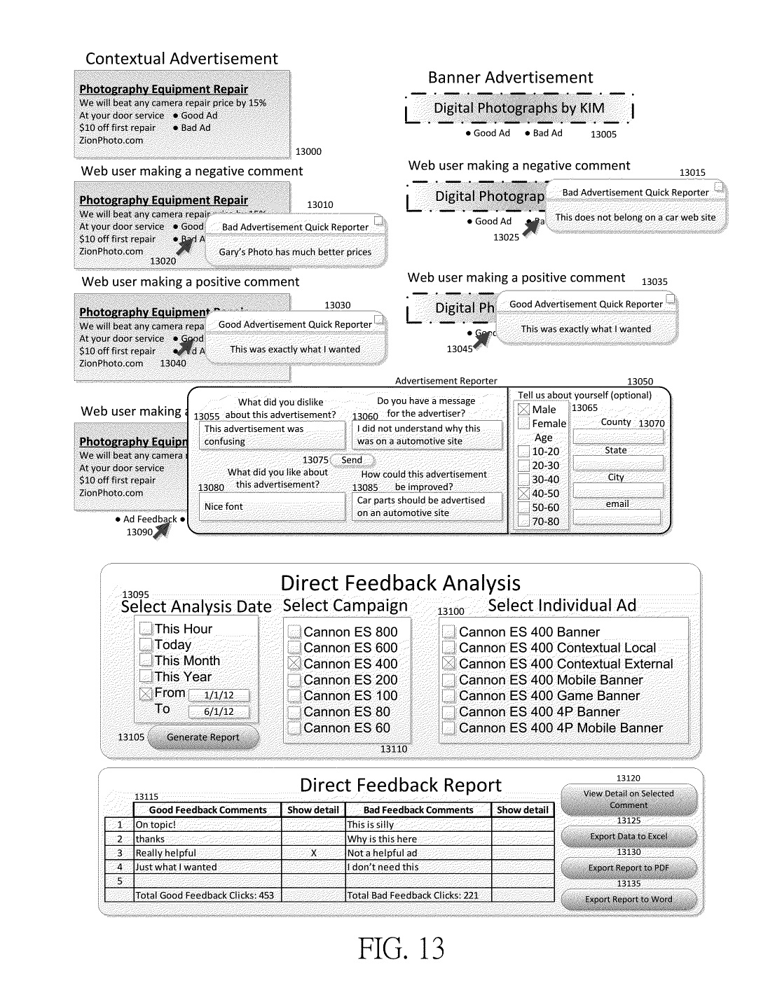

Referring now to FIG. 13 examples of direct feedback, the setup for a direct feedback report and a sample report are presented. In a simple feedback system we can see a contextual advertisement with an additional “good ad” and “bad ad” link (13000) in the contextual advertisement or near it. Note that “good ad” and “bad ad” are examples and any text or symbol combination could be used to solicit feedback from the web user. When the web user clicks on the “bad ad” link (13020) we can see a small pop up (13010) that allows the web user to leave feedback. The web user can simply close the window letting the advertiser know that the web user did not appreciate this advertisement. In this example, the web user has left feedback that a competitor has better prices. The user can also leave a positive comment by clicking on the “good ad” link (13040) and a roll-over window appears (13030). This allows the user to either click it closed which would leave the marketer with an indication that the user liked the advertisement or leave a comment. In this example the user left a comment. Banner (display) advertisements can also have feedback. A standard banner advertisement would have an additional “good ad” and “bad ad” link (13005) in the contextual advertisement or near it. Like the contextual advertisement, the web user can click the “bad ad” link (13025) and a roll-over window will appear (13015). This allows the user to either click it closed which would leave the marketer with an indication that the user disliked the advertisement or leave a comment. In this example the user left a negative comment. Like the contextual advertisement, the web user can click the “good ad” link (13045) and a roll-over window will appear (13035). This allows the user to either click it closed which would leave the marketer with an indication that the user liked the advertisement or leave a comment. In this example the user left a positive comment.

If the marketer wishes, they can set up an advertisement to have detailed feedback. There would be a small “ad feedback” link (13090). Note that “ad feedback” is an example and any text or symbol combination could be used to solicit feedback from the web user. When the user clicks on the link (13090) a roll-over window appears (13050) with an area for leaving detailed feedback. The user could indicate what they disliked about the advertisement (13055) and what the liked about the advertisement (13080) in a text format. The user could also send a message to the advertiser (13060) and suggest improvements for the advertisement (13085). In this example, the web user is dismayed that the advertisement for a photography product appeared on their automotive web site. Armed with this feedback, the marketer could investigate why their advertisement appears on an automotive web site. With some key word/phrase or campaign adjustments the advertisement would stop appearing on automotive sites. This would save the marketer money by not advertising in unintended places. The web user is also prompted to provide demographic information about themselves. This includes gender and age (23065) and their location (13070).

The marketer is able to generate a report that shows the results of the feedback submitted by the web users. The marketer starts by selecting the dates of the analysis (13095). The marketer then enters in the campaign (13110) and the individual advertisements (13100). The marketer then generates the report (13105). The report (13115) shows the good feedback comments, the bad feedback comments and a summary of the number of the good and bad comments. This data can be exported to Excel (13125) PDF (13130) and to Word (13135). The marketer can also get detailed 10 information on a selected comment (12120). This includes the particular advertisement that was served to the web user, the web search string (if applicable) that caused this advertisement to be displayed, user information, date/time, demographics, search history, suggestions for improvement by the web user (if left or if applicable), notes from the web user (if left or if applicable) and any other information on the page being displayed.

17) Complete report. Every quarter, most marketers need to file a report on how effective their marketing efforts were. The database (server) algorithm has the ability to generate this complete report. This would save the marketer valuable time and give them a complete picture on their experience with this technology. The report generated would have the complete Account Performance report and include Cost-Per-Click (CPC), Cost Per Mille (CPM), Click Through Rate (CTR), Click Through Success (CTS), Return on Investment (ROI), Effective Cost Per Thousand Impressions (eCPM) and Total Capital Invested (TCI). The report would also have a summary of what money was spent on advertising and when this was spent. The report can be either in Excel, PDF or word format.

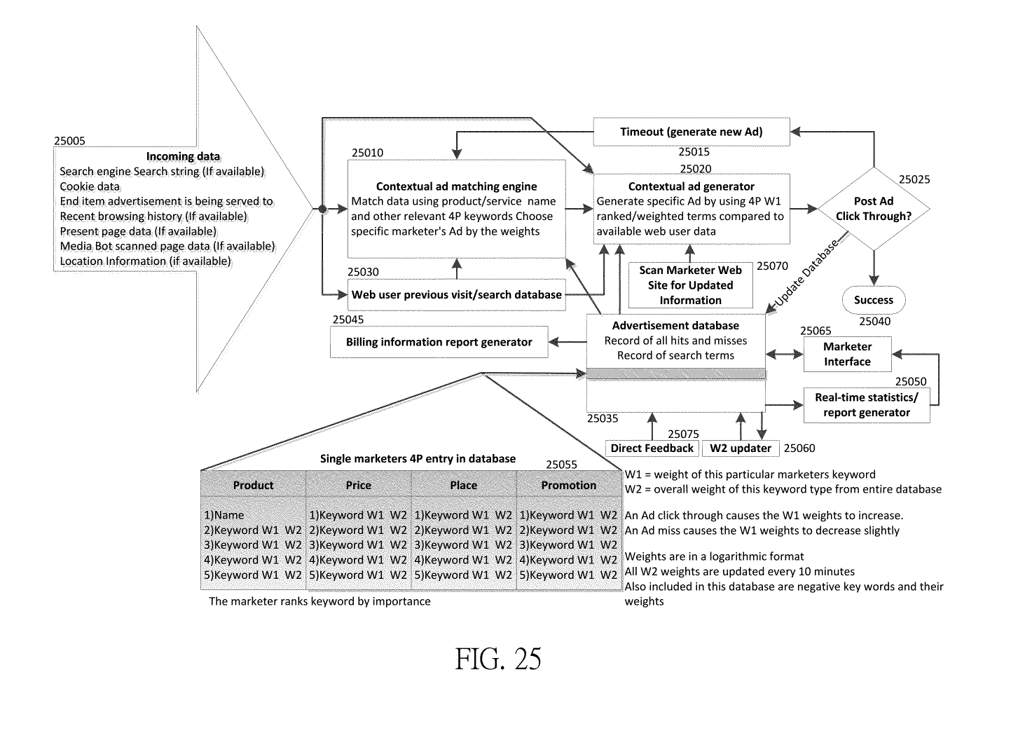

Turning now to FIG. 25, a method 25000 begins that builds on method 1100 that was presented in the 61/494,133 patent. This updated method begins at 25005, the entry point for the database (server) algorithm system. The search engine feeds in user query 30 that contains the search string, cookie data, location of the user (if available), recent browsing history (if the user has been using the search engine long enough to have history) and the end item (web browser, mobile browser, game, computer application or media player). If the actual page for the search has additional relevant information this is sent along as well. If there is no search engine query string, the advertisement the database (server) algorithm uses the available information on the page, cookie data, end item, location and recent browsing history. In the instance where no search page is present, a web bot will scan the page and recover the web page data and use this to feed the system rather than using a search string. This information is sent to the matching engine 25010, the contextual advertisement generator 25020 and previous history database 25030. The more information that is sent to the database (server) algorithm the more exact the match would be to a particular 4P contextual advertisement.

The advertisement matching engine 25010 is one of two major decision units that make up the database (server) algorithm system. The function of this step is to take all of the relevant information about the query and match it to the 4P advertisements in the database. The relevant information from 25005 includes a search string, cookie data, end item, location recent browsing history, user previous history and information on the present page. The algorithm can cross reference this to the users past history. For example, if the user had recently done searches on cooking ingredients, a preference would be given to marketing advertisements that include such items.

The first step is identifying the end item (web browser, mobile browser, game, application or media player) use. This would match the end item to the proper marketer's campaign type. A contextual advertisement match is made by first settling on a topic of an advertisement. This would be a match between the search string and the product/service name. The algorithm for text matching would be a Rabin-Karp type string search algorithm or similar string matching algorithm. Different weights on the individual 4P weights would determine the best fit for the data. Negative 4P key words would also help with the best fit by directing matches away from undesired advertisements. 4P rules are also used to limit advertisements that best apply to the user. The weights would all be added up for every possible marketers 4P advertisement and selecting the best possible choices. The match would then be further narrowed down by matching previous history, and current web page information. The database would exclude advertisements that the particular user has already seen to keep up their interest. At this point a particular marketer's individual optimized 4P advertisement would be chosen and passed along to the contextual advertisement generator 25020.

If a user has not clicked on the advertisement by a certain time (approximately 1 minute) the advertisement would time 25015 out and a new advertisement would be sent to the user. This would restart the process at 25010 and proceed to the contextual advertisement generator step 25020 of the database (server) algorithm.

The matching engine has selected a specific 4P marketer's advertisement to be sent 25025 to the user. The generator uses the search string, cookie data, the end item, the location the user's previous visit/search history, and information on the present page. To develop a targeted advertisement, weights would be applied to this data and the best possible targeted advertisement would be generated. The advertisement generator gets information from the advertisement matching engine 25010 the user previous visit/search database 25030, the incoming data 25005 and the advertisement database 25025.

Once the advertisement is served to the user, the advertisement would be either clicked on or have a time out 25025. If it is clicked on then the successful click would be recorded in the advertisement database 25035. At the same time, the W1 weights of that particular marketer's 4P advertisement would be increased. The effect of increasing these weights would increase the likelihood that the advertisement is served more often as it is a successful formula. If an advertisement is not successful in a given time period, a new advertisement is generated 25015.

If the advertisement is not clicked on then another advertisement is sent to the user. The database is also informed that the particular marketer's 4P advertisement was not successful and the W1 weights for that that particular advertisement would be adjusted. The adjustment would slightly reduce the weights in the order in which they were sorted by the keyword. For example the #1 promotion keyword would be reduced by 0.1% and the #10 keyword by 0.001%. This would reduce the likelihood that the advertisement would be served again. To buck the trend of constantly pulling the average down, either by random or by the users of this technology or by automated database analysis a single keyword weight on that particular 4P advertisement would be increased by a large amount for every negative click through. The effect of this would be to shake up the weights so that the weight combination with the highest effectiveness would rise to the top. This would find the sweet spot of what users are looking for.

The user previous visit/search database 25030 contains all the previous searches and other user information that all visitors to the search engine web site have made. This would be used to develop a profile of the individual user. From this, individual preferences and purchasing patterns would emerge that help make optimal advertisement placement. This information is fed to the advertisement matching engine 25010 and the advertisement generator 25020.

The full database of all marketing mangers' 4P advertisements 25035 contains all the hits and misses for various search terms. This is the central database which all the database (server) algorithm data is taken from. It is used to serve the decision making and report generation. The database is constantly being polled by various service tasks to produce reports and generate advertisements. It directly serves 25010, 25020, 25045, 25050 and 25060. An expansion of an individual database record is in 25055. The individual entry database contains the positive and negative key words with the key phrase. This is used to generate the individual advertisement.

The result of all the efforts in entering information into the database and utilizing this technology is a successful click on a generated contextual advertisement 25040. The database (server) algorithm makes profits from successful click troughs and 4P marketing campaigns 25045. All of this information is in the advertisement database 25035 and must be combed through to determine billing information. This information is in the form of a report that is sent to each marketing manager to collect payment.

As marketing mangers' 4P advertising campaign progresses, marketing mangers needs to see how successful it is. The information in the advertisement database 25035 and would be combed through to see each generated advertisement, how successful each attempt was and what the search terms got an advertisement generated 25050. Marketing managers would then refine the order of the keywords and change keywords in an attempt to get better advertising success.

The expansion 25055 of each 4P record contained in the 25035 database and this shows that every 4P item has many keywords in a specific ranking. The ranking order determines which keyword is the highest priority and therefore most likely to get picked by the advertisement generator or matching engine. Marketing managers would be able to see the weights and this would tell them if they are in the right track in their ranking. For example, if a marketer accidently entered a key word of “shoe sale” and their product was tires, this key word's weight by natural attrition have a high value indicting that it was a low priority to be served to the web user. The key word report would show the marketer that this is not a good key word and the marketer would then realize their mistake and eliminate that poorly chosen key word.

There is a service task 25060 to comb through all the weights, searches, other relevant information in the advertisement database 25055 and users of this technology input to adjust the overall weights. The randomizing effect of shaking up the weights would make it so that the most successful key words would be rippled to the top. In addition the users of this technology would input biases on weights by analyzing all the marketers key words and adjusts them be best performance. This helps, for example, around the holidays. Higher priority would be given to the keyword “Christmas Day Sale”.

There is a marketing interface that the marketer can enter and update their advertisement data 25065. This would be used at the beginning of the campaign to enter in the advertisement, and update it as the campaign proceeds. There is also a bot that scans the marketer's site, their API and their database for changing information 25070 to display continuously linked data. Feedback from the web view may be entered into the database 25075.

Weights and scores can be represented in logarithmic format, for proportionally higher rewards to successful advertising campaigns. It also slowly reduces a less successful advertising campaign. This is done by having a non-linear log scale that places a high value on click through success. Click trough's are naturally not going to occur often as the Internet is constantly bombarding users with advertisements. So a single success is important and an unsuccessful click through is a minor failure.

From FIG. 25 it is obvious how the search engine is chosen for marketing mangers' advertisements. When a search string comes in, a most appropriate 4P advertisement is chosen based on keywords and weights. From marketer's perspectives, their 4P chooses the most appropriate search string.

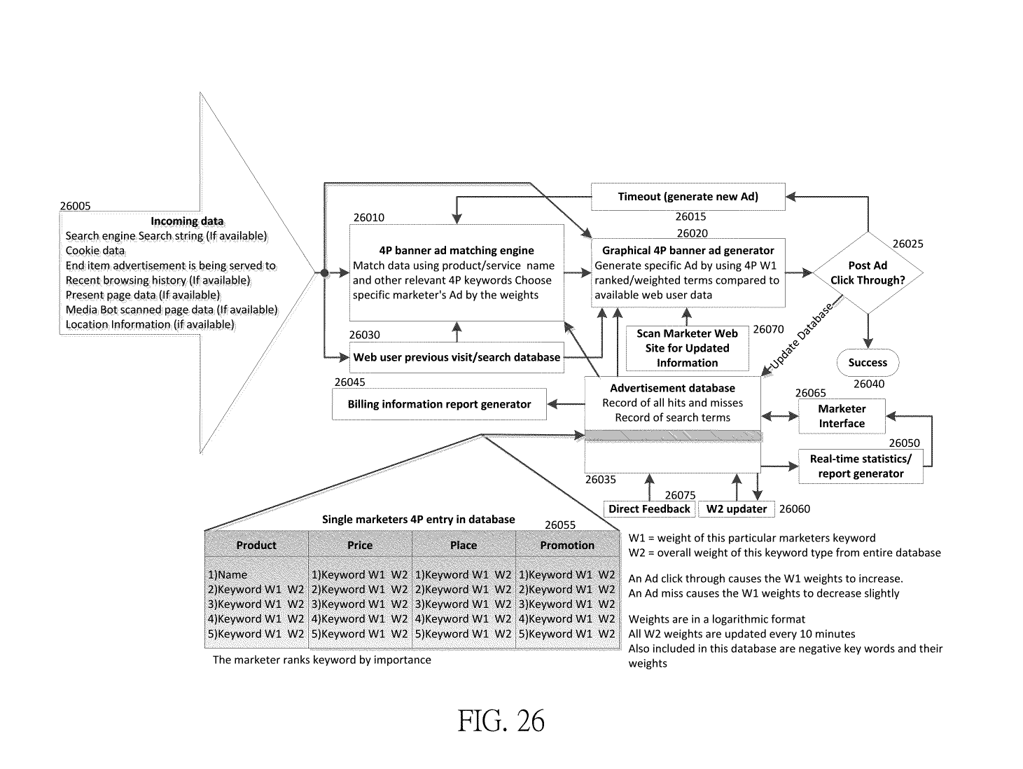

Turning now to FIG. 26, a method 26000 begins that builds on method 1100, 1200 that was presented in the 61/494,133 patent. Method 25000 is similar to method 25000 except it generates graphical 4P banner advertisements instead of 4P contextual advertisements. This updated method begins at 26005, the entry point for the database (server) algorithm. The search engine feeds in user query that contains the search string, cookie data, location of the user (if available), recent browsing history (if the user has been using the search engine long enough to have history) and the end item (web browser, mobile browser, game, application or media player). If the actual page for the search has additional relevant information this is sent along as well. If there is no search engine query string, the advertisement the database (server) algorithm uses just available information on the page, cookie data, end item, location and recent browsing history. In the instance where no search page is present, a web bot will scan the page and recover the web page data and use this to feed the system rather than using a search string. This information is sent to the matching engine 26010, the 4P banner (display) advertisement graphical generator 26020 and previous history database 26030. The more information that is sent to the database (server) algorithm the more exact the match would be to a particular 4P banner (display) advertisement.

The advertisement matching engine 26010 is one of two major decision units that make up the database (server) algorithm. The function of this step is to take all of the relevant information about the query and match it to the 4P advertisements in the database. The relevant information from 26005 includes a search string, cookie data, end item, location recent browsing history, user previous history and information on the present page. The algorithm can cross reference this to the web users past history. For example, if the user had recently done searches on cooking ingredients, a preference would be given to marketing advertisements that include such items.

The first step is identifying the end item (web browser, mobile browser, game, application or media player) use. This would match the end item to the proper marketer's campaign type. A 4P banner (display) advertisement match is made by first settling on a topic of an advertisement. This would be a match between the search string and the product/service name. The algorithm for text matching would be a Rabin-Karp type string search algorithm or similar string matching algorithm. Different weights on the individual 4P weights would determine the best fit for the data. Negative 4P key words would also help with the best fit by directing matches away from undesired advertisements. 4P rules are also used to limit advertisements that best apply to the user. The weights would all be added up for every possible marketer's 4P banner (display) advertisement and selecting the best possible choices. The match would then be further narrowed down by matching previous history and current web page information. The database would exclude advertisements that the particular user has already seen to keep up their interest. At this point a particular marketer's individual optimized 4P banner (display) would be graphically generated and passed along to 26020.

If a user has not clicked on the 4P banner (display) advertisement by a certain time (approximately 1 minute) the advertisement would time 26015 out and a new 4P banner (display) advertisement would be sent to the user. This would restart the process at 26010 and proceed to the 4P banner (display) advertisement generator step 26020 of the database (server) algorithm.

The matching engine has selected a specific 4P marketer's 4P banner (display) advertisement to be sent 26025 to the user. The generator uses the search string, cookie data, the end item, the location the web user's previous visit/search history, and information on the present page. To develop a targeted advertisement, weights would be applied to this data and the best possible targeted advertisement would be generated. The 4P banner (display) advertisement generator gets information from the advertisement matching engine 26010 the user previous visit/search database 26030, the incoming data 26005 and the advertisement database 26025.

Once the 4P banner (display) advertisement is served to the user, the advertisement would be either clicked on or have a time out 26025. If it is clicked on then the successful click would be recorded in the advertisement database 26035. At the same time, the W1 weights of that particular marketer's 4P banner (display) advertisement would be increased. The effect of increasing these weights would increase the likelihood that the advertisement is served more often as it is a successful formula. If an advertisement is not successful in a given time period, a new advertisement is generated 26015.

If the 4P banner (display) advertisement is not clicked on then another advertisement is sent to the user. The database is also informed that the particular marketer's 4P banner (display) advertisement was not successful and the W1 weights for that that particular advertisement would be adjusted. The adjustment would slightly reduce the weights in the order in which they were sorted by the keyword. For example the #1 promotion keyword would be reduced by 0.1% and the #10 keyword by 0.001%. This would reduce the likelihood that the advertisement would be served again. To buck the trend of constantly pulling the average down, either by random or by the users of this technology or by automated database analysis a single keyword weight on that particular 4P advertisement would be increased by a large amount for every negative click through. The effect of this would be to shake up the weights so that the weight combination with the highest effectiveness would rise to the top. This would find the sweet spot of what users are looking for.

The user previous visit/search database 26030 contains all the previous searches and other user information that all visitors to the search engine web site have made. This would be used to develop a profile of the individual user. From this, individual preferences and purchasing patterns would emerge that help make optimal advertisement placement. This information is fed to the advertisement matching engine 26010 and the 4P banner (display) advertisement generator 26020.

The full database of all marketing mangers' 4P advertisements 26035 contains all the hits and misses for various search terms. This is the central database which all the database (server) algorithm data is taken from. It is used to serve the decision making and report generation. The database is constantly being polled by various service tasks to produce reports and generate advertisements. It directly serves 26010, 26020, 26045, 26050 and 26060. An expansion of an individual database record is in 26055. The individual entry database contains the positive and negative key words with the key phrase. This is used to generate the individual advertisement.

The result of all the work of setting up this advertisement on the database (server) algorithm is a successful click on a graphically generated 4P banner (display) advertisement 26040. The database (server) algorithm profits from successful click troughs and 4P marketing campaigns 26045. All of this information is in the advertisement database 26035 and must be combed through to determine billing information. This information is in the form of a report that is sent to each marketing manager to collect payment.

As marketing mangers' 4P advertising campaign progresses, marketing mangers needs to see how successful it is. The information in the advertisement database 26035 and would be combed through to see each generated advertisement, how successful each attempt was and what the search terms got an advertisement generated 26050. Marketing managers would then refine the order of the keywords and change keywords in an attempt to get better advertising success.

The expansion 26055 of each 4P record contained in the 26035 database and this shows that every 4P item has many keywords in a specific ranking. The ranking order determines which keyword is the highest priority and therefore most likely to get picked by the advertisement generator or matching engine. Marketing managers would be able to see the weights and this would tell them if they are in the right track in their ranking. For example, if a marketer accidently entered a key word/phrase of “Shoe Sale” and their product was tires, this key word's weight by natural attrition have a high value indicting that it was a low priority to be served to the web user. The key word report would show the marketer that this is not a good key word and the marketer would then realize their mistake and eliminate it.

There is a service task 26060 to comb through all the weights, searches, other relevant information in the advertisement database 26055 and users of this technology would input to adjust the overall weights. The randomizing effect of shaking up the weights would make it so that the most successful key words would be rippled to the top. In addition the users of this technology would input biases on weights by analyzing all the marketers key words and adjusts them be best performance. This helps, for example, around the holidays. Higher priority would be given to the keyword “Christmas Day Sale”.

There is a marketing interface that the marketer can enter and update their advertisement data 26065. This would be used at the beginning of the campaign to enter in the advertisement, and update it as the campaign proceeds. There is also a bot that scans the marketer's site, their API and their database for changing information 26070 to display continuously linked data. Feedback from the web view may be entered into the database 26075.

Weights and scores can be represented in logarithmic format, for proportionally higher rewards to successful advertising campaigns. It also slowly reduces a less successful advertising campaign. This is done by having a non-linear log scale that places a high value on click through success. Click trough's are naturally not going to occur often as the Internet is constantly bombarding users with advertisements. So a single success is important and an unsuccessful click through is a minor failure.

From FIG. 26 it is obvious how the search engine is chosen for marketing mangers advertisements. When a search string comes in, a most appropriate 4P advertisement is chosen based on keywords and weights. From marketer's perspectives, their 4P chooses the most appropriate search string.

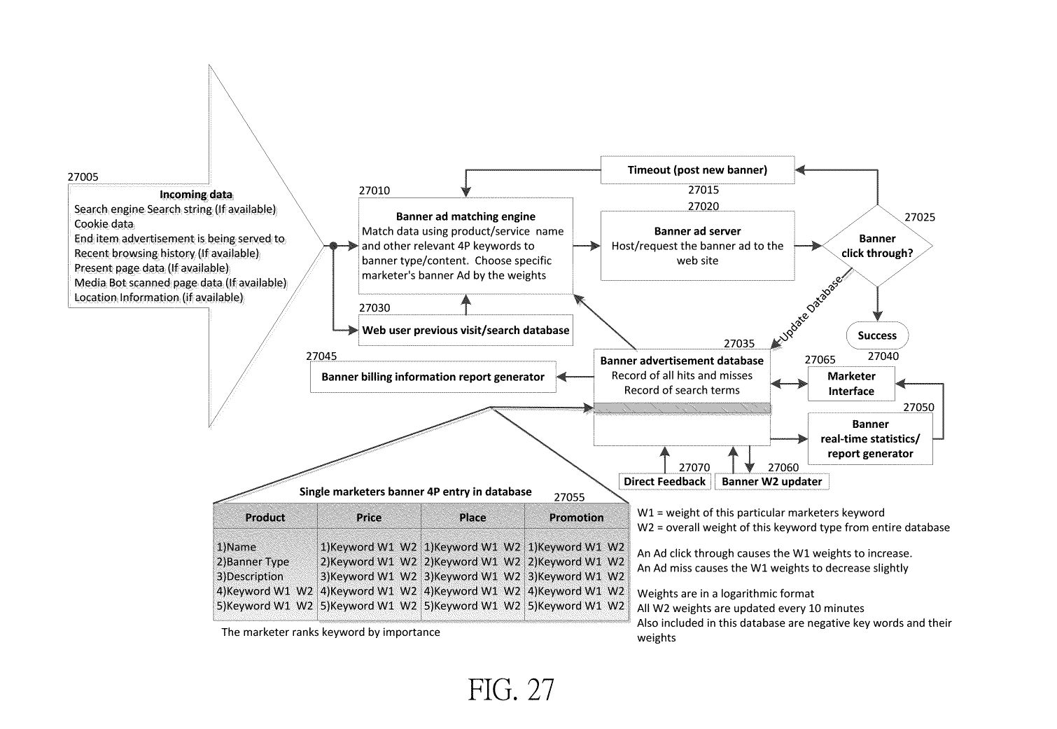

Turning now to FIG. 27, a method 27000 begins that builds on method 1200 that was presented in the 61/494,133 patent. This updated method begins at 27005, the entry point for the database (server) algorithm. Method 27000 is similar to method 25000 except it does not generate contextual advertisements but instead it serves up banner (display) advertisements. Functionally these are similar but there are some key differences. These are in the Banner Matching Engine 27010, the Banner Advertisement Server 27020 and the banner (display) advertisement database 27035.

Method 27000 begins at 27005. This is the entry point for the database (server) algorithm. The database (server) algorithm is presented with user query that contains the search string (if available), cookie data, location of the user (if available), recent browsing history (if the user has been using the search engine long enough to have history), the web page data (scanned by a bot) and the end item (web browser, mobile browser, game, application or media player). This information is sent to the matching engine 27010, the banner (display) advertisement server 27020 and previous history database 27030. The more information that is sent to the database (server) algorithm, the more exact the match would be to a particular 4P banner (display) advertisement.

The banner (display) advertisement matching engine 27010 is one of two major decision units that make up the banner (display) system. The function of this module is to take all of the relevant information available about the user and match it to the 4P banner (display) advertisements in the database. Note that banner (display) advertisements are slightly different as the content of the banner (display) is described in the 4P section of the database and there is no generation of an advertisement. The relevant information from 27005 includes: search string, cookie data, recent browsing history, user location (if available), end item (web browser, mobile browser, game, application or media player), user previous history and information on the present page. In addition, it can cross reference this to the web users past history. For example if the user had recently done searches on cooking ingredients, preference would be given to marketing banner (display) advertisements that included these items.

The first step is identifying the end item (web browser, mobile browser, game, application or media player) use. This would match the end item to the proper marketer's campaign type. A match is made by first settling on a topic of a banner (display) advertisement. This would be a match between the search string or information about the user and the web page that they are on and the product/service name. The algorithm for text matching would be a Rabin-Karp type string search algorithm or similar string matching algorithm. Different weights on the individual 4P weights would determine the best fit for the data. Negative 4P key words would also help with the best fit by directing matches away from undesired advertisements. 4P rules are also used to limit advertisements that best apply to the user. The weights would all be added up for every possible marketers 4P advertisement and selecting the best possible choices. It would then be further narrowed down by matching previous history, and current web page information. The database would exclude banner (display) advertisements that the particular user has already seen to keep up their interest. At this point a particular marketer's individual optimized banner (display) advertisement would be chosen and passed along to 27020. Note that while the database (server) algorithm would select the particular banner (display) advertisement from 4P criteria, the actual banner (display) likely will not contain all of the 4P information that was instrumental in selecting the particular banner (display) served to the web user.

If a user has not clicked on the banner (display) advertisement by a certain time (approximately one minute) the banner (display) advertisement would time 27015 out and a new advertisement would be sent to the user. This would restart the process at 27010.

The banner (display) advertisement server step 27020 of the banner (display) system. The banner (display) matching engine has selected a specific 4P marketer's banner (display) advertisement to be sent to the user 27025. The server either hosts the banner (display) advertisement itself or queries a remote server at a banner (display) host site to send the banner (display) advertisement to the user. The generator uses: the search string, cookie data, the end item, the location, the web user's previous visit/search history and information on the present page. To develop a targeted advertisement, weights would be applied to this data and the best possible targeted advertisement would be generated. The advertisement server gets information from the advertisement matching engine 27010.

Once the banner (display) advertisement is served to the user, the banner (display) advertisement would be either clicked on or have a time out 27025. If it is clicked on then the successful click would be recorded in the advertisement database 27035. At the same time, the W1 weights of that particular marketer's 4P banner (display) advertisement would be increased. The effect of increasing these weights would increase the likelihood that the banner (display) advertisement is served more often as it is a successful formula. If an advertisement is not successful in a given time period, a new banner (display) advertisement is served 27015.

The database is also informed that the particular marketer's 4P advertisement was not successful and the W1 weights for that that particular banner (display) advertisement would be adjusted. The adjustment would slightly reduce the weights in the order in which they were sorted by the keyword. For example the #1 promotion keyword would be reduced by 0.1% and the #10 keyword by 0.001%. This would reduce the likelihood that the advertisement would be served again. To buck the trend of constantly pulling the average down, either by random or by the users of this technology or by automated database analysis a single keyword weight on that particular 4P advertisement would be increased by a large amount for every negative click through. The randomizing effect of shaking up the weights would make it so that the most successful key words would be rippled to the top. This would find the sweet spot of what users are looking for and serve the best banner (display) advertisements.

The user previous visit/search database 27030 contains all the previous searches and other user information that all visitors to the search engine web site have made. This would be used to develop a profile of the individual user. From this, individual preferences and purchasing patterns would emerge that help make optimal banner (display) advertisement placement. This information is fed to the banner (display) advertisement matching engine 27010.

The result of all the setting up an advertisement through the database (server) algorithm is a successful click on a graphically generated banner (display) advertisement 27040. The database (server) algorithm makes profits from successful click troughs and 4P marketing campaigns 27045. All of this information is in the advertisement database 27035 and must be combed through to determine billing information. This information is in the form of a report that is sent to each marketing manager to collect payment.

As marketing mangers' 4P advertising campaign progresses, marketing mangers needs to see how successful it is. The information in the advertisement database 27035 and would be combed through to see each generated advertisement, how successful each attempt was and what the search terms got an advertisement generated 27050. Marketing managers would then refine the order of the keywords and change keywords in an attempt to get better advertising success.

There is a marketing interface that the marketer can enter and update their advertisement data 27065. This would be used at the beginning of the campaign to enter in the advertisement, and update it as the campaign proceeds. Feedback from the web view may be entered into the database 27070.

Weights and scores can be represented in logarithmic format, for proportionally higher rewards to successful advertising campaigns. It also slowly reduces a less successful advertising campaign. This is done by having a non-linear log scale that places a high value on click through success. Click trough's are naturally not going to occur often as the Internet is constantly bombarding users with advertisements. So a single success is important and an unsuccessful click through is a minor failure.

The full database of all marketer's banner (display) advertisements 27035 contains all the hits and misses for various search terms. This is the central database which all the database (server) algorithm data is taken from. It is used to serve the decision making and report generation. The database is constantly being polled by various service tasks to produce reports and change weights. It directly serves 27010, 27045, 27050 and 27060. An expansion of an individual banner (display) database record is in 27055. The individual entry database contains the positive and negative key words with the key phrase. This is used to generate the individual advertisement. The result of all the database (server) algorithm is a successful click on a banner (display) advertisement 27040.

From FIG. 27 it is obvious how the search engine is chosen for marketing mangers advertisements. When a search string comes in, a most appropriate banner advertisement is chosen based on keywords and weights. From marketer's perspectives, their 4P chooses the most appropriate search string.

Although the invention has been explained in relation to its preferred embodiment, it is to be understood that many other possible modifications and variations can be made without departing from the spirit and scope of the invention as hereinafter claimed.

What is claimed is:

1. A method of contextual/banner (display) advertising report generation comprising:
An ability of the advertiser/marketer to generate reports for a single advertising campaign, multiple advertising campaigns or their entire advertising portfolio; furthermore the reports are over a period specified by the marketer and include: cost per click, cost per mille, click through rate, click through success, return on investment, effective cost per thousand impressions, total capital invested, reach and frequency, web user feedback, user feedback analysis and click fraud analysis; wherein the reports may be exported to Word, Excel or PDF; wherein the reports may also be demographic, geographic, by web site (URL), by individual key word and by the individual web site that the advertisement is served to.

2. A method of game/application contextual/banner (display) advertising report generation comprising:
An ability of the advertiser/marketer to generate reports for a single advertising campaign, multiple advertising campaigns or their entire advertising portfolio; furthermore the reports are over a period specified by the marketer and include: cost per click, cost per mille, click through rate, click through success, return on investment, effective cost per thousand impressions, total capital invested, reach and frequency, web user feedback, user feedback analysis and click fraud analysis; wherein the reports about the game or application may be exported to Word, Excel or PDF; wherein the reports may also be demographic, geographic, by web site (URL), by individual key word and by the individual web site that the advertisement is served to.

3. A method of contextual advertising account setup comprising:
An ability where by the advertiser/marketer may select a 4P keyword, enter a phrase to go along with the key word and link data to the keyword and set up rules for the keyword; in addition, they may select a negative keyword that will prevent their advertisement from appearing where it is not desired; in addition they are able to select the rank of the positive/negative key words that give priority to the key words.

4. A method of contextual advertising 4P key word rules setup comprising:
An ability where by the advertiser/marketer may select a rule that compares linked data to a set value and if valid displays a key phrase, a rule that take a linked competitors price and reduces it by a certain amount but no lower than a certain amount, A rule that displays a key phrase during a specified date and time, a rule that compares user demographics/information to set criteria and displays a key phrase if the criteria is met and a rule that displays a key phrase if the web user is in a specific geographic region.

5. A method of contextual advertising advertisement feedback comprising:
A system of advertisement feedback that allows the web user to instantly give feedback to the marketer on the banner/contextual advertisement that they are viewing; wherein the web user is able to clink on a link near the advertisement that records their positive and negative feeling toward the advertisement and this would bring up a window where the web user could type in their specific opinion; wherein this information would be recorded and used to influence future advertisement placement and generation.

6. A method of banner (display) advertising comprising:
A system where by the banner (display) (animated gif, movie, a static JPG, a transparent picture, an audio file, an interactive flash, a java script or an HTML file) is defined by product/service price place and promotion key words describing the contains of the banner which gives the ability to have a computer algorithm display the banner more effectively as the computer algorithm has superior knowledge of the banner (display) advertisement contents.

7. A method of 4P banner (display) advertising comprising:
A system where by the banner (display) (animated gif, movie, a static JPG, a transparent picture, an audio file, an interactive flash, a java script or an HTML file) advertisement is put together with product/service price place and promotion key words/phrases [including real time updated information and rules directing the key words] describing the product/service being advertised and depending on the search phrase of the web user a combination of product/service price place and promotion key words/phrases is put together in graphical format to make a custom banner (display) advertisement specific to the web user whereby making a more effective advertisement.

8. A method of 4P of contextual/banner (display) advertising for mobile device advertising comprising:
An ability to display 4P contextual advertisements, banner (display) advertisements [with 4P key words to describe their content] and banner (display) advertisements generated with 4P key phrases that all display on a mobile device and use an advertising campaign that is optimized to take advantage of the mobile web users location and develop 4P key words that are optimized by the marketer to take advantage of a mobile device and the mobile device user.

9. A method of 4P of contextual/banner (display) advertising for game advertising comprising:
An ability to display 4P contextual advertisements, banner (display) advertisements [with 4P key words to describe their content] and banner (display) advertisements generated with 4P key phrases that all display before/after and within a video game and use an advertising campaign that is optimized to take advantage of the relevant information within the video game, and the video game user and develop 4P key words that are optimized by the marketer to have their advertisement take advantage of a the video game environment.

10. A method of 4P of contextual/banner (display) advertising for computer application advertising comprising:
An ability to display 4P contextual advertisements, banner (display) advertisements [with 4P key words to describe their content] and banner (display) advertisements generated with 4P key phrases that all display on before/after and within a computer application with an advertising campaign that is optimized to take advantage of the relevant information within the computer application, and the computer application user and develop 4P key words that are optimized by the marketer to have their advertisement take advantage of a the computer application environment.

11. A method of 4P of contextual/banner (display) advertising for media player advertising comprising:
An ability to display 4P contextual advertisements, banner (display) advertisements [with 4P key words to describe their content] and banner (display) advertisements generated with 4P key phrases that all display on before/after and within a media player with an advertising campaign that is optimized to take advantage of the relevant information within the media player and the media player user and develop 4P key words that are optimized by the marketer to have their advertisement take advantage of a the media player environment.

12. A method of alerting the marketer to the status of their advertising campaign comprising:
An ability for the marketer to set up one or many alerts in the event that their advertisement, advertising campaign is not preforming up to the standards that they set in the area of CPC, CPM, CTR, CTS, ROI, eCPM, TCI, Reach and Frequency, Click Fraud, advertising budget, API interface, error good feedback and bad feedback which if exceed a set limit would fax, instant message, text message, tweet, automated (computer generated) call, email update the marketers API or shut down the campaign all of which would prevent the marketer from wasting money on an advertising campaign that is not preforming well and reduce public relations damage.

13. A method of marketer advertising campaign management comprising:
An ability of the marketer to select a single campaign or advertisement, edit it, copy it, delete it, activate or deactivate it which would allow time savings of the copying then editing of a campaign or individual advertisement, multiple advertisements with minor differences that can then be set up quickly.

14. A method of reporting the success of and advertising campaign comprising:
A formula known as Click Through Success (CTS) takes the amount of click through's to the marketers site and divides this by the number of sales that the marker made expressed as a percentage which relates to how successful an advertisement is at conveying what the marketer's site has to offer.

15. A method of matching web user information with a marketer's advertisement database to create 4P contextual advertisements.
A computer algorithm takes user query that contains the search string (if available), cookie data, location of the user (if available), recent browsing history (if the user has been using the search engine long enough to have history), the web page data (scanned by a bot) and the end item (web browser, mobile browser, game, application or media player) and this is matched to an advertisement database of marketers Product/Service, Price, Place and Promotion positive/negative key words/phrases with that give the data importance, which when combined with weights and rules, positive/negative feedback a 4P contextual advertisement is developed/served to a web user then analyzed for success and the 4P positive/negative key words weights are adjusted based on this success to give the web user the best possible 4P contextual advertisement and the marketer a database of information to generate reports to understand their advertisements and advertising campaigns.

16. A method of matching web user information with a marketer's advertisement database to create banner (display) advertisements described with 4P.
A computer algorithm takes user query that contains the search string (if available), cookie data, location of the user (if available), recent browsing history (if the user has been using the search engine long enough to have history), the web page data (scanned by a bot) and the end item (web browser, mobile browser, game, application or media player) and this is matched to an advertisement database of marketers Product/Service, Price, Place and Promotion positive/negative key words/phrases with that give the data importance, which when combined with weights and rules, positive/negative feedback to serve a banner (display) advertisement that is described by using 4P key words which is served to a web user and then analyzed for success and the 4P positive/negative key words weights are adjusted based on this success to give the web user the most effective banner advertisement and the marketer a database of information to generate reports to understand their banner (display) advertisements and banner (display) advertising campaigns.

17. A method of matching web user information with a marketer's advertisement database to create 4P banner (display) advertisements.
A computer algorithm takes user query that contains the search string (if available), cookie data, location of the user (if available), recent browsing history (if the user has been using the search engine long enough to have history), the web page data (scanned by a bot) and the end item (web browser, mobile browser, game, application or media player) and this is matched to an advertisement database of marketers Product/Service, Price, Place and Promotion positive/negative key words/phrases with that give the data importance, which when combined with weights and rules, positive/negative feedback a banner (display) advertisement is graphically generated, developed and served to a web user then analyzed for success and the 4P positive/negative key words weights are adjusted based on this success to give the web user the best possible 4P banner (display) advertisement and the marketer a database of information to generate reports to understand their 4P banner (display) advertisements and 4P banner (display) advertising campaigns.
